(19) United States
(12) Patent Application Publication
(10) Pub. No.: US 2021/0258144 A1
(43) Pub. Date: Aug. 19, 2021

(54) SYSTEMS AND METHODS FOR MARKING AND AUTHENTICATING SCARCE ITEMS

(71) Applicant: HASHQUIN LLC, New York, NY (US)

(72) Inventor: Nelson MINIER, New York, NY (US)

(21) Appl. No.: 17/176,010

(22) Filed: Feb. 15, 2021

Related U.S. Application Data
(60) Provisional application No. 62/975,845, filed on Feb. 13, 2020.

(51) Int. Cl. H04L 9/06; H04L 9/32; G06K 19/06

(52) U.S. Cl. CPC H04L 9/0643; H04L 9/3236; H04L 2209/56; H04L 2209/38; G06K 19/06037

(57) ABSTRACT

A system and method for marking, validating ownership, proving authenticity, tracking provenance, and verifying scarcity of items utilizing cryptology. A unique Origination Hash is generated in accordance with specific characteristics unique to each item plus the Purchaser Identity and an Origination Secret provided by the User. A physical representation of the Origination Hash is produced and attached, embedded, or formed in a discrete location on an item. A Birth Certificate, including a HashPrint is generated from the Origination Hash and is written to the BITCOIN Blockchain to generate an immutable, time stamped record of the purchase of the specific item by the user. Access to a secure website allows for verification of user ownership, the authentication of items, the transfer of items, and an item's Status.

### CROSS REFERENCE TO RELATED APPLICATIONS

This Application claims the benefit of U.S. Provisional Patent Application Ser. No. 62/975,845 filed Feb. 13, 2020, and titled SYSTEMS AND METHODS FOR MARKING AND AUTHENTICATING SCARCE ITEMS, the disclosure of which is hereby incorporated by reference in its entirety into this application.

### BACKGROUND OF THE INVENTION

The present invention relates generally to anti-counterfeiting, authentication, manufacturing of rare articles, electronic communications, and association transference of unique articles between users and more specifically, it finds particular application in conjunction with electronic transactions between users and providers, particularly with respect to articles capable of authentication as to provenance and will be described with particular reference thereto.

According to the latest data available, the Organisation for Economic Co-operation and Development (OECD) estimates that trade in counterfeit and pirated products represented over 3.3% of all global trade in 2016. This is equivalent to over $500 billion annually. The study also documents that the growth of counterfeiting and pirating is accelerating at rapid pace. The OECD estimates that trade in fake goods represented about 2.5% of world trade in 2013. The risks associated with the trade in counterfeit goods are numerous and significant in an increasingly globalized and knowledge-based economy. In addition to the damage done to intellectual property rights, counterfeit goods can pose serious health and safety risks to consumers, particularly in the medical equipment, pharmaceutical, food and beverage, and garment industries. Trade in counterfeit goods steals revenues from companies and governments. It can also be a source of funds for any number of criminal enterprises.

Counterfeiters are attracted to this trade given the massive size of the markets, the high profit margins and the very low risk of detection. Despite the efforts of global organizations such as the OECD to protect trademarks, copyrights and intellectual property, there are limited tools or technologies available to assist their efforts.

Many consumers unwittingly purchase counterfeit or pirated products believing they are purchasing genuine articles. Others knowingly buy fake goods, attracted by the low price without regard for the quality or safety of the product. Internet based commerce platforms such as FACEBOOK, INSTAGRAM, EBAY, ETSY, etc. provide easy access to the markets for counterfeiters. Consumer interest in limited edition or production runs of articles of manufacture, such as shirts, shoes, collectibles, memorabilia, jewelry, etc. is increasing. In some instances, secondary markets have arisen in which these scarce items are being bought and sold. Unfortunately, a buyer is generally limited to the identity and reputation of the seller as being indicative of the authenticity of the product. The buyer generally cannot examine the article prior to purchase. Further, examination of the item by the buyer, unless the buyer is an expert, may not provide any indicia as to the authenticity of the item being purchased.

Currently, the inability of buyers, sellers, and manufacturers to provide proof of ownership or confirm the authenticity of items in the marketplace contributes to the proliferation of counterfeit and pirated items being made available to consumers. With no way to ascertain the authenticity, a presumably well-made counterfeit item would be indistinguishable from an authentic item and thus desirable for purchase by consumers.

Any discussion of the prior art throughout this specification should in no way be considered as an admission that such prior art is widely known or forms part of the general knowledge in the field. Current anti-counterfeit and authentication systems do not create scarcity, verify ownership and authenticity of unique items, nor verify provenance and other item details using cryptology and BITCOIN blockchain technology.

### BRIEF SUMMARY OF THE INVENTION

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In accordance with one aspect of the present disclosure, there is provided a method for marking, validating ownership, proving authenticity, tracking provenance, and verifying scarcity of items utilizing cryptology that comprises generating, with a Hash Generator, an Origination Hash associated with a specific item, and generating a hash from the Origination Hash. The method further includes writing, with a Blockchain Writer, a Birth Certificate associated with the hash from the Origination Hash to the BITCOIN blockchain; and physically marking the specific item with the Origination Hash

In accordance with another aspect of the present disclosure there is provided a system for marking, validating ownership, proving authenticity, tracking provenance, and verifying scarcity of items utilizing cryptology. The system includes a server computer system that comprises a processor, a Hash Generator, a Blockchain Writer, a Payment Monitor, and a memory in communication with the processor. The memory stores instructions which are executed by the processor, causing the processor to host a website accessible by a plurality of user devices via an associated computer network, and receive, via the website, user information associated with an item. The memory further stores instructions to generate, in accordance with the received user information, a unique Origination Hash via the Hash Generator, and generate, via the Hash Generator, a hash from the Origination Hash. In addition, the memory includes instructions to write, via the Blockchain Writer, a Birth Certificate associated with the hash from the Origination Hash to the BITCOIN blockchain.

In accordance with another embodiment, there is provided an article of manufacture comprising a physical Origination Hash affixed to the article.

In one embodiment, the physical Origination Hash affixed to the article is generated by an associated Hash Generator in accordance with SHA 256. In accordance with another embodiment, the article is selected from the group of an article of clothing, a pair of shoes, a collectible, a piece of jewelry, an accessory, a piece of memorabilia, or a luxury good.

### BRIEF DESCRIPTION OF THE DRAWINGS

The subject disclosure may take form in various components and arrangements of components, and in various steps and arrangement of steps. The drawings are only for purposes of illustrating the preferred embodiments and are not to be construed as limiting the subject disclosure.

FIG. 1 is a functional block diagram of a system and method for marking, validating ownership, proving authenticity, tracking provenance, and verifying scarcity of items utilizing cryptology in accordance with one aspect of the exemplary embodiment.

FIG. 2 is a functional block diagram of a user device for use in the system and method for marking, validating ownership, proving authenticity, tracking provenance, and verifying scarcity of items utilizing cryptology in accordance with one aspect of the exemplary embodiment.

FIG. 3 is a functional block diagram of a manufacturer system for use in the system and method for marking, validating ownership, proving authenticity, tracking provenance, and verifying scarcity of items utilizing cryptology in accordance with one aspect of the exemplary embodiment.

FIG. 4 is a flowchart of an exemplary system and method for marking, validating ownership, and proving authenticity of items utilizing cryptology in accordance with one aspect of the exemplary embodiment.

FIG. 5 is a flowchart of an exemplary system and method for verifying authenticity and tracking provenance of scarce items in accordance with one aspect of the exemplary embodiment.

FIG. 6 is a flowchart of an exemplary method for Transferring Ownership of scarce items in accordance with one aspect of the exemplary embodiment.

FIG. 7 is a flowchart of an exemplary method for reporting changes in Status of scarce items in accordance with one aspect of the exemplary embodiment.

FIG. 8 is a flowchart of an exemplary method for verifying and ensuring the scarcity of items by a Sealing process in accordance with one aspect of the exemplary embodiment.

FIG. 9 is an exemplary screenshot of an Origination Hash creation screen in accordance with one aspect of the exemplary embodiment.

FIG. 10 an exemplary screenshot of a public authentication screen showing Retrieval Details in accordance with one aspect of the exemplary embodiment.

FIG. 11A an exemplary screenshot of a private authentication screen showing Full Item Details in accordance with one aspect of the exemplary embodiment.

FIG. 11B an exemplary screenshot of a screen showing Full Item Details in accordance with one aspect of the exemplary embodiment.

FIG. 12 is an exemplary screenshot of an item Status change to In Transfer reporting screen in accordance with one aspect of the exemplary embodiment.

FIG. 13 is an exemplary screenshot of a Transfer acceptance screen in accordance with one aspect of the exemplary embodiment.

FIG. 14 is an exemplary screenshot of a change Status screen in accordance with one aspect of the exemplary embodiment.

FIG. 15 is an exemplary screenshot of a revert Status screen in accordance with one aspect of the exemplary embodiment.

FIG. 16 is an exemplary screenshot of a verification of Closing Seal screen in accordance with one aspect of the exemplary embodiment.

FIG. 17 is an exemplary screenshot of a blockchain verification screen in accordance with one aspect of the exemplary embodiment.

FIG. 18 is an exemplary screenshot of an Item Lost screen in accordance with one aspect of the exemplary embodiment.

FIG. 19 is an exemplary screenshot of a Sealed Line in accordance with one aspect of the exemplary embodiment.

FIG. 20 is an exemplary Merkel Tree Diagram of a Line in accordance with one aspect of the exemplary embodiment.

FIG. 21 is an exemplary screenshot of a proof of ownership screen in accordance with one aspect of the exemplary embodiment.

FIG. 22 is an exemplary screenshot of a proof of ownership after transfer screen in accordance with one aspect of the exemplary embodiment.

### DETAILED DESCRIPTION OF THE INVENTION

The exemplary embodiments are described herein with reference to preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

One or more implementations of the subject application will now be described with reference to the attached figures, wherein like reference numerals are used to refer to like elements throughout.

In varying embodiments disclosed herein, a system (“HashQuin”) provides a verification platform and methodology that provides luxury brands, scarce items, and consumers a mechanism to protect the value of their assets with irrefutable authentication. There are four core elements covered by the HashQuin methodology and processes. First, the system proves ownership. The fact that an individual possesses and controls an item cannot be disputed once the item is generated in the HashQuin system. Secondly, the system confirms an item's authenticity; that fact that an item is genuine and of undisputed origin. The third element is HashQuin's ability to verify provenance; the historical record of ownership of the item. This ensures that an item can be sold in a secondary transaction with a verifiable ledger of transactions. Finally, and very importantly, HashQuin verifies an item's scarcity. That is, an item can be proven to be of a certain lineage of a limited-edition item that cannot be reproduced. The result of securing these four attributes of an item is that counterfeits are easily identified and discredited. As used hereinafter, the terms “Item” and “item” are intended to identify a valuable/scarce item purchased or available for purchase by a user. Unless otherwise indicated, the terms may be used interchangeably to represent such an article, regardless of the type of article references, e.g., clothing, accessories, shoes, jewelry, collectibles, etc.

The HashQuin system utilizes specific definitions for terms and components. The following is illustrative of a listing of definitions corresponding to terms and components recited in varying embodiments of the systems and methods described herein, forms a part of this description, and is incorporated by reference in its entirety herein.

As used herein, the term “Origination Hash or OH” may be used as the identifying “fingerprint” of each item. The OH may be created by running the Origination Hash Item Details through an SHA 256 hashing function. The Origination Hash is the resulting output of this process and is a string of 64 characters that is unique to that item. The entire OH (or a subset of it) is physically placed/located on the inside of all HashQuin Verified Items. As will be understood in accordance with the systems and methods set forth below, the OH may be used to irrefutably tie the Item to the owner.

As used herein, the term “SHA 256” or “Secure Hash Algorithm 256” refers to the algorithm defined in FIPS 180-4, which is a mathematical equation that is utilized in various forms of encryption. As will be appreciated by those skilled in the art, SHA 256 may be used extensively to secure payments on e-commerce websites, as well as for various blockchain applications. SHA 256 is a mathematical process that always generates a 256 bit (64 character) long random sequence of letters and numbers, called a “hash” given any input. The input may be letters, numbers, words or even punctuation marks and may be of any length. SHA 256 is a one-way function meaning that the process cannot be reversed—the hash will never reveal the original input data.

As used herein, “Origination Hash Item Details” or “OHID” corresponds to the inputs used to create the Origination Hash. In accordance with one embodiment contemplated herein, the OHID may include, for example and without limitation the Line Name, Line Scarcity, Line Number, Lineage Number, Purchaser Identity and Origination Secret, as those terms are defined below.

As used herein, the term “Line” is used to designate a single category and color of clothing items, e.g., a black pullover hoodie, a pair of shoes, an article of jewelry, or other article of manufacture, i.e. a product line of goods.

The term “Line Name”, as used hereinafter, corresponds to a unique identity of a Line. That is, a first Line, e.g., a black pullover hoodie, may be given the Line Name “XXXX.” The Line Name (i.e., “XXXX”) may be one of the Origination Hash Item Details used to create the Origination Hash.

The term, “Line Scarcity”, as used herein, refers to the total number of items produced in a Line. According to one embodiment of the subject application, the number of items in each Line will be pre-determined and made known prior to its production. For example, since 210 items will be produced in the first Line, the Line Scarcity for the “XXXX” hoodie will be 210. The Sealing process and the creation of a Closing Seal for each Line ensures that the Line Scarcity remains immutable. The Line Scarcity may be one of the OHID used to create the OH.

As used herein , the term “Lineage Number” refers to the sequential number of the item within a Line. For example, the exemplary black pullover hoodie XXXX 207 will have Lineage Number 207. Lineage Number may be one of the OHID used to create the OH.

The term “Purchaser Identity” or “PI”, as used herein, refers to the name or the pseudonym created by a buyer of an item at the time of purchase. Purchaser Identity may be one of the OHID used to create the OH.

As used herein, the term “Origination Secret” or “OS” is used to refer to a password, code, biometric identifier, alphanumeric sequence, or the like, selected by the user at the time of purchase. Origination Secret may be one of the OHID used to create the OH.

The term “Full Item Details” or “FID” is used herein to refer to an exhaustive list of all the particular features of a specific item. In accordance with one embodiment of the subject disclosure, the FID may be accessible by entering the OH, PI and OS into the HashQuin website. In some embodiments, the FID may include the Status of an item.

As used hereinafter, the term “Retrieval Details” or “RD” corresponds to a list of basic details about a specific Item that may be accessible by entering at least one of the OH, the Origination Hash or the Latest OH into the HashQuin website. The Retrieval Details may be implemented as a subset of the details contained in the FID.

The term “Birth Certificate”, as used herein, corresponds to the documented credential that is visible on the blockchain generated when an item is purchased and the associated transaction is recorded on the Bitcoin blockchain. According to one embodiment, the Birth Certificate may include the Origination Hash, the Birth Date, the Line Name and the Lineage Number of the item. As will be appreciated by those skilled in the art, the Bitcoin blockchain comprises an immutable time stamp; wherein the “birth” of the Item may be commemorated.

As used herein, the term “Birth Date” corresponds to the time stamp information registered on the Bitcoin blockchain when an item is initially purchased. In accordance with one exemplary embodiment, the Birth Date is shown in UTC Time in ISO-8601 format. This is a 24-hour format referencing the Universal Time Coordinated standard. For example: Jan. 14, 2020 at 1:08:32 pm in New York City during Daylight Savings Time would be designated as 2020-01-14T18:08:32Z.

The term “Item History”, as utilized herein, represents the entire provenance of a specific item, listing all transfers of ownership beginning at the Birth Date. The IH may not include the OS. The IH may or may not include the PI as the current owner has the option to obfuscate this information during the Transfer process. The IH may include the item's Origination Hash and subsequent Latest Origination Hash, if any.

The term “Hash Print” corresponds to the hash of the OH; i.e. it may be generated by running the OH though an SHA 256 hashing function. The Hash Print is included on an Item's Birth Certificate and resides on the Bitcoin blockchain. It will be appreciated that because the Hash Print may only be determined with the input of the OH, the owner has discretion over the disclosure of an Item's provenance and Birth Certificate. In one embodiment, the owner may maintain the OH as a secret; accordingly, in such an embodiment an Item's Origination Hash cannot be determined. It will be appreciated, however, that the owner can reproduce the Hash Print at will.

“Status”, as used herein, refers to an Item's present condition and may be ascertained when the OH or the Origination Hash is entered into the HashQuin website. According to one embodiment, the Status is not associated with a subjective measure of an Item's physical condition. On HashQuin, an Item's Status may be defined to be one of six specifically defined conditions as follows: “Exist”, “Does Not Exist”, “Compromised”, “Lost”, “Stolen”, “In Transfer”, as defined below.

The term “Exist” corresponds to the Item being present in the real-world. When the Origination Hash is entered for an Item, the Retrieve Details will be shown. When the OH is entered for an Item, the Full Item Details will be shown.

The term “Does Not Exist” corresponds to when the Item cannot be found in the database when either the OH or the Origination Hash is entered.

The term “Compromised” corresponds to when it is discovered that an item has been copied. This designation can be entered by the owner or by HashQuin administrators. Once an Item's Status has been changed to Compromised, its Status cannot be changed by either the owner or a HashQuin administrator.

The term “Lost” corresponds to when the Item is declared missing by the last owner. If the owner later finds the Item, the owner or a HashQuin administrator is able to change the item's Status back to Exist.

The term “Stolen” corresponds to when the last owner declares the Item stolen. An Item with this Status is no longer transferable via the HashQuin platform. If the owner later recovers the Item, the owner or a HashQuin administrator is able to change the item's Status back to Exist.

The term “In Transfer” corresponds to when the Item is being transferred between parties.

As used herein, “Transferring Ownership” refers to a change in ownership of the Item within the HashQuin platform, preserving an Item's authenticity and provenance, thereby keeping intact the Item History. According to one embodiment, the process is accomplished jointly between the current owner (“Seller”) and the prospective owner (“Buyer”). The transfer process (introduced in the definition of “Transfer” below) requires a number of steps to be executed on the HashQuin website. These include the creation of a Transfer Secret and hashes. The entire provenance of the Item is maintained via the HashQuin website, however the Buyer is the only one that can prove ownership once the Transfer is complete.

The term “Transfer Secret” or “TST”, as used herein, corresponds to a secret (or password) created and shared by both the Buyer and Seller. In accordance with one embodiment, the TST may be required for use in the Transfer process in addition to the OH. Because the OH is physically visible on the item, the TST provides another layer of security in case the Item's physical delivery is intercepted.

As used herein, the term “Transfer” corresponds to the process used to assign ownership of an Item from a Seller to a Buyer. According to one embodiment contemplated herein, the Transfer is a multistage process involving the physical transfer of an Item either in-person or by mail or courier, the verification of the transfer, and the verification of the new owner through the generation of a new hash via the HashQuin website. This new hash is written to the Bitcoin Blockchain. This immutably time-stamps the Transfer of the Item. In accordance with one embodiment, HashQuin does not facilitate the physical exchange of the Item or any payments that may be involved. HashQuin only facilitates the identification and verification of the new owner in the HashQuin database. This occurs once both parties are satisfied that the payment and the Item have been successfully exchanged. By performing the Transfer utilizing the HashQuin system, the Buyer is authenticated as the new owner of the Item and the Item History, provenance, is updated and assured.

In accordance with one embodiment, the following example illustrates the Transfer of an Item and the corresponding actions that may occur during the transition of ownership from the Seller to the Buyer. The Seller provides the Buyer with a Transfer Secret and the Origination Hash of the item prior to initiating the Transfer process on the HashQuin website. The Origination Hash is provided so that the item's Retrieval Details can be viewed and accepted by the Buyer. HashQuin does not facilitate the exchange of this information between Buyer and Seller; it is accomplished on a communications platform agreed upon by the Buyer and the Seller.

On the website, the Seller must change the Status of an item to In Transfer. Once an item is designated as In Transfer, the Seller will be prompted to submit the OH, the Origination Secret, and the Transfer Secret thereby confirming ownership. The Seller will be given the option to obfuscate their Personal Identity so that this information will not be included in the Item History thereafter.

Once the Seller receives payment and the Buyer receives the item, the Transfer will be executed and the new owner will be verified on the HashQuin website as per the following process.

The Buyer will acknowledge and confirm possession of the item by entering the OH, the Transfer Secret, their own Purchaser Identity, and their own Origination Secret into the website. The Buyer will know the OH as it is physically printed on the inside of the item and is on a QR code label also located in the item. The OH, the new owner's Purchaser Identity, and the new owner's Origination Secret will be run through the SHA 256 function and the resulting hash will be the Latest Hash Print. The Latest Hash Print will be written to the Bitcoin Blockchain. The transaction will be shown in the Item History. The Buyer will now be recognized as the owner of the item and be able to provide proof of ownership.

As used herein, the term “Latest Hash Print” refers to the most recent hash of the OH, the Buyer's (the new owner) Purchaser Identity, and the Buyer's (the new owner) Origination Secret that is generated during the Transfer. According to one embodiment, the Latest Hash Print is time stamped and written to the Bitcoin blockchain as part of the Transfer process. It will be appreciated that the Latest Hash Print enables independent verification of an item's ownership and history. In such an embodiment, the Latest Hash Print is displayed in the Retrieval Details and the Item History.

The term “Hard Marker”, as used herein, corresponds to a physical identifier that may be applied to each item. Hard Markers are indicators (for example, a painted spray pattern or tiny beads) of various shapes and colors applied in different locations on an Item. The type and location of an Item's Hard Marker is documented and included in the item's Full Item Details.

The term “Hard Identity” corresponds to the identification of an Item based upon the Hard Marker affixed to each Item. Each item may be physically “labeled” with one of various “Hard Markers” that will be unique to each item. Used in conjunction with the OH, the Hard Identity provides another level of security to an Item. The Hard Identity is discerned through the identification of a Hard Marker on an Item. The presence of a Hard Marker helps to verify an Item's authenticity. It can only be confirmed by a HashQuin administrator.

As used herein, the term “Binding” corresponds to a process utilized when an “Item” is made up of two or more pieces, as in the case of a pair of shoes. Binding involves splitting the OH into pieces in order to link the parts of an item together cryptographically. In the example of a pair of shoes, the OH is split in two. The OH is a 64-character string of random letters and numbers. The first 32 characters of the OH can be applied on one shoe and the last 32 characters of the OH can be applied to the other shoe. The process links the separate parts of an item together forever and increases the security of the item's authenticity.

The term “Sealing”, as used herein, corresponds to the process that may be used to permanently close a Line after the final item of the Line has been purchased. Every Line consists of a limited edition of items, as designated by Line Scarcity. The Sealing process ensures the Line can never be produced again, guaranteeing the Line Scarcity will never change.

The term “Closing Seal”, as used herein, corresponds to the encrypted confirmation of the closing of Line. According to one embodiment, the Closing Seal is generated by combining the Origination Hash of every Item in the Line in Lineage Number order and running it through the SHA 256 function. The resulting hash is the Closing Seal. Thereafter, it will be possible to confirm the total number and the lineage of the Items in the Line using either the OH or Hash Print of an Item in a Line. The Closing Seal is time stamped and written to the Bitcoin blockchain as part of the Sealing process. This allows for independent verification of an Item's Lineage Number and the Line Scarcity.

As used herein, the term “Sealing Date” corresponds to the time stamp information registered on the Bitcoin blockchain when a Line's Seal is created. The Sealing Date is shown in UTC Time in ISO-8601 format. This is a 24-hour format referencing the Universal Time Coordinated standard. For example: Jan. 14, 2020 at 1:08:32 pm in New York City during Daylight Savings Time would be designated as 2020-01-14T18:08:32Z.

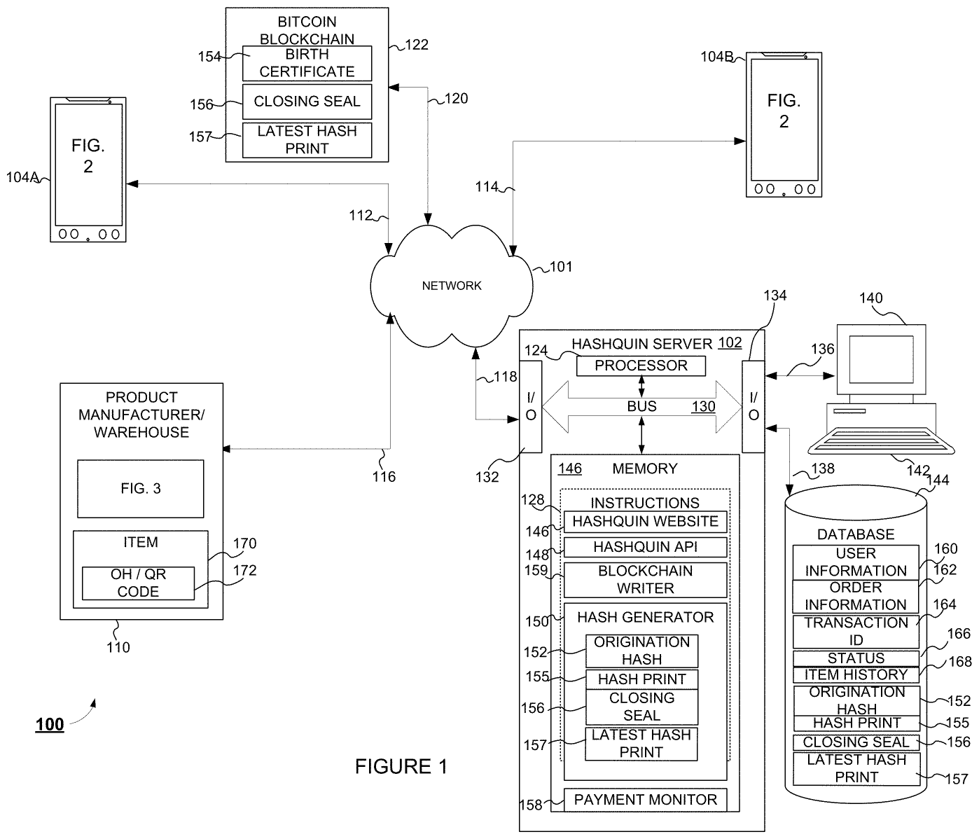

Referring now to FIG. 1, there is shown a system 100 configured for marking, validating ownership, proving authenticity, tracking provenance, and verifying scarcity of items utilizing cryptology of scarce items in accordance with one embodiment of the subject application. As used herein, an item may include, for example and without limitation, an article of clothing, collectible, shoes, jewelry, accessory, memorabilia, luxury goods, and the like. It will be appreciated that the foregoing is intended as a non-exhaustive list of physical items capable of being marked and authenticated in accordance with the systems and methods described herein. Further, the systems and methods set forth herein, particularly on the user side, are intended to be platform-independent, i.e., access and use of the systems and methods by the user (device) may occur across different and/or multiple platforms and/or operating systems as known by those of skill in the art. It will be appreciated that the various components depicted in FIG. 1 are for purposes of illustrating aspects of the exemplary embodiment, and that other similar components, implemented via hardware, software, or a combination thereof, are capable of being substituted therein.

As shown in FIG. 1, the system 100 includes a HashQuin central system (generally referred to herein as “HashQuin Operations”) represented generally as the server computer system 102, which is capable of implementing the exemplary method described below. The exemplary server computer system 102 includes a processor 124, which performs the exemplary method by execution of processing instructions 128 that are stored in memory 126 connected to the processor 104, as well as controlling the overall operation of the server computer system 102. It will be appreciated that the system 100 illustrates a single server computer system 102, however, the skilled artisan will appreciate that multiple such server computer systems 102 may be used herein to perform one or more of the operations discussed hereinafter. In accordance with other embodiments, a plurality of distinct server computer systems 102 are utilized, e.g., a third party cloud service, to implement the systems and methods set forth herein. According to one embodiment, the HashQuin Operations may include hardware as well as instructions/code on a remote cloud service (e.g., AWS) that control the processing of the system 100 as described below. In one such exemplary embodiment, operations may be written in Golang, a MariaDB database for information storage, and the like.

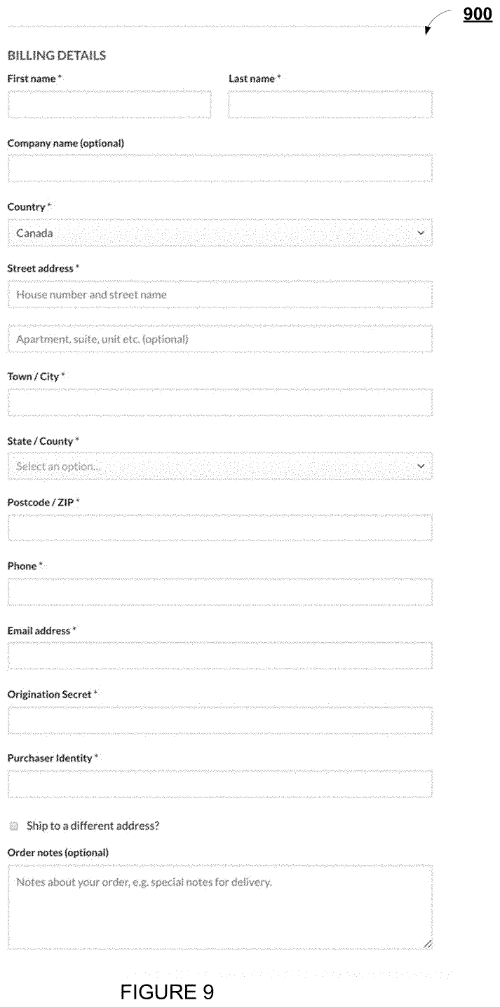

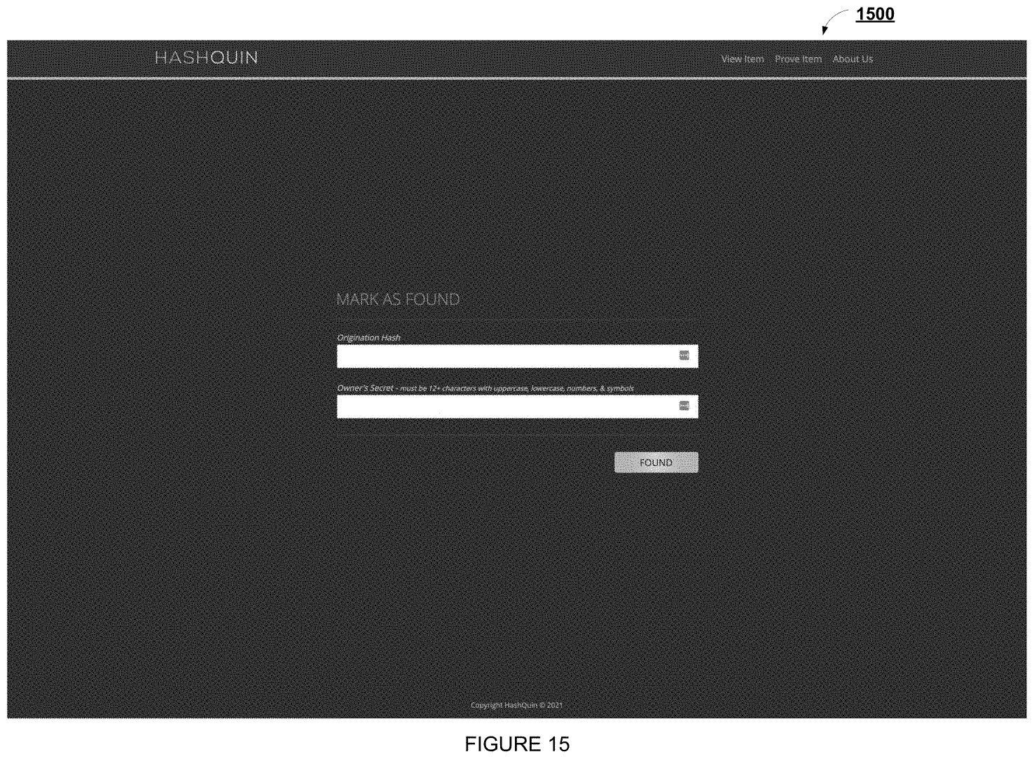

The instructions 128 include a HashQuin website 146 configured to host/display a website accessible by users via a computer network 101, e.g., the Internet, LAN, VLAN, etc. In varying embodiments, the HashQuin website 146 is secured via known security protocols, utilizing Purchaser Identity (as used herein, the term “Purchaser Identity” shall be as defined in HashQuin—List of Terms)/Origination Secret combinations, as well as publicly accessible portions, or pages, providing general information to visitors regarding the services and items provided thereon. It will be appreciated that the HashQuin website 146 may be hosted by a third-party service provider (e.g., AMAZON WEB SERVICES (AWS), or similar provider), and thus may be hosted on a different device than the server 102 depicted in FIG. 1. The website 146 may be implemented as, for example and without limitation, a Wordpress-based website, allowing users to interact with a HashQuin API 148, and to purchase items 170 via a suitable WooCommerce plugin, as discussed in greater detail below. Accordingly, the skilled artisan will understand that the illustration of FIG. 1 is intended as an example of one potential implementation of the subject systems and methods. In accordance with one embodiment, the website 146 may be accessed via a suitable web address, as will be understood by those skilled in the art. It will further be appreciated by the skilled artisan that the website 146 provides a suitable user interface enabling the users to interact with the various features and functions of the HashQuin system 100. Exemplary illustrations of the interactions and screens accessible/provided by the website 146 are depicted in FIGS. 9-17, further described below.

According to one nonlimiting example embodiment, the HashQuin website 146 is a user interface (UI) that allows users to interact with various HashQuin functions. The website 146 is hosted on an ec2 instance in AWS. Once an item 170 has been purchased, users can employ the Hashquin website to retrieve a subset of details about their item, retrieve the full details about their item, transfer the ownership of an item, or change the Status of an Item 170. HashQuin 102 has an API 148 that facilitates all of the actions taken by a user of the HashQuin website 146. This API 148 is hosted on an ec2 instance on AWS. When a user attempts to interact with their item, for example, retrieve full item details, the HashQuin website 146 sends an API call to the HashQuin API 148. The HashQuin API 148 then retrieves or updates data found in the HashQuin database 144. The HashQuin API 148 then returns a response so that it can be viewed on the HashQuin website 146.

HashQuin 102 runs a Bitcoin node on an ec2 instance on AWS. This is hosted on the same ec2 instance as the Payment Monitor 158, Blockchain Writer 159, and Hash Generator 150. The Blockchain Writer 159 sends an RPC call to this node, which in turn writes the information to the Bitcoin blockchain 122. Users are able to look up their item 170 in two ways. The first method provides the Retrieval Details. By entering a valid Hash Print 155, an API call is performed, HashQuin 102 looks up the Hash Print 155 in the database 144, and if there is a match, it returns the Retrieval Details to the user. The second method requires the user to enter the Hash Print 155 and also the Origination Secret. An API call is performed. The database 144 is checked for the supplied hash 152 and then is checked to ensure that the Origination Secret matches the information in the database 140 for this item 170. If there is a match, a complete set of item details is returned to the user.

Users can also use the HashQuin website 148 to change the status of an item 170 in the event that an item's identity is compromised (duplicated or counterfeited) or if an item 170 was lost or stolen. The user enters the Hash Print 155 and the Origination Secret and HashQuin 102 checks the database 144 to confirm if there is a match. If there is a match, the item's status is updated in the database 144. Any subsequent requests for item details will return an additional notation that the item's Status has been changed. Users can also transfer ownership of their item 170. This process requires both the Seller and the Buyer to enter specific information. An API call is made. If the specific information supplied by the Seller specific information supplied by the Buyer, the database 144 is updated with the new owner's information. The new owner can now verify ownership using the website 146 in accordance with the methods set forth herein. It will be understood that the preceding example is one possible interaction with the various components disclosed herein, and other interactions are contemplated.

The instructions 128 further include a HashQuin Application Program Interface (API) 148 configured to enable a user to access information via the website 146 relating to items 170, authentication, ownership, transfer of ownership, purchases, and the like. The skilled artisan will appreciate that the API 148 may be implemented in varying forms and capabilities to control the passage of information between the website 146, the Blockchain Writer 159, the Hash Generator 150, the Payment Monitor 158, and the Database 144. In accordance with one embodiment, the API 148 returns information from the Database 144 requested by the website 146 or updates data based on inputs from the website 146. In varying embodiments contemplated herein, the API 148 facilitates the control of the passage of information between the website 146, the operations of the system 100, and the BDS instance.

Included in the instructions 128 of the server 102 is a Hash Generator 150 configured to generate a unique Origination Hash 152 for an item 170 purchased by a user in accordance with the systems and methods set forth in the subject application. As illustrated in FIG. 1, the Hash Generator 150 is configured to generate an Origination Hash 152, a Hash Print 155, a Closing Seal 156, and a Latest Hash Print 157 associated with a unique item 170. The Origination Hash 152 is generated using the Origination Hash Item Details OHID utilizing item information, user information 160, order information 162, and the like. It will be appreciated that the Origination Hash 152 may be a series of alphanumeric characters uniquely identifying a specific item 170 in accordance with the systems and methods set forth herein. Stated another way, the Hash Generator 150 employs a set of instructions that are executed to create an alphanumeric, cryptographic signature called a hash. Additional information regarding the generation of the Origination Hash 152, the Hash Print 155, Closing Seal 156 and/or Latest Hash Print 157 are discussed in greater detail below.

The instructions 128 further include a Payment Monitor 158 configured to process, monitor, and facilitate payment for the scarce item 170 acquired by the user in accordance with the systems and methods described herein. According to one embodiment, the Payment Monitor 158 is configured to monitor both BITCOIN and credit card payments. The Payment Monitor 158 may be implemented to routinely perform API calls to a suitable eCommerce component, e.g. WooCommerce or other suitable processing component/plugin as will be understood by those skilled in the art. In some embodiments, the API calls may check for items 170 for which payment has been successfully received. Further, the Payment Monitor 158 may be configured to identify new item purchases, parsing of item details, and recording of the payment information to the Database 144.

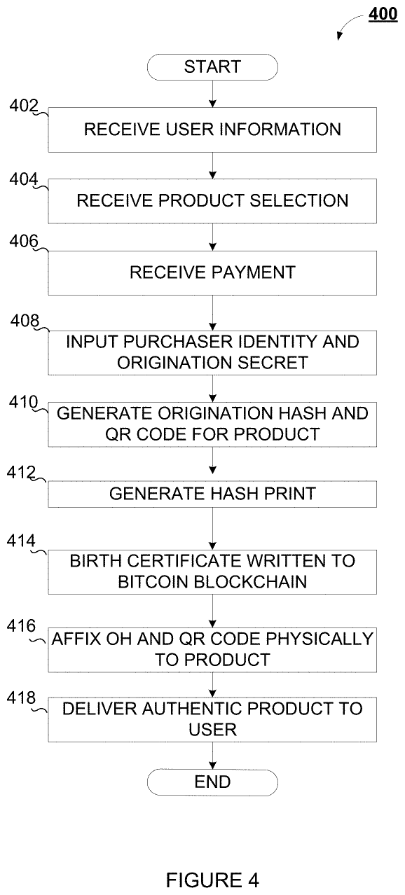

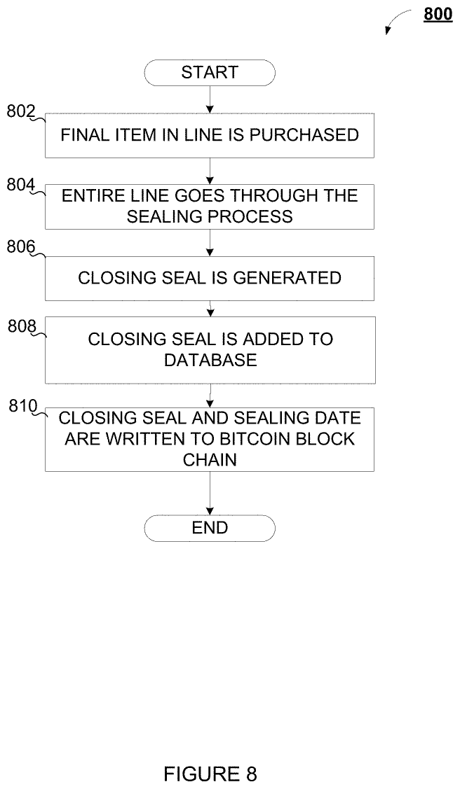

As illustrated in FIG. 1, the instructions 128 also include a Blockchain Writer module 159 configured to interact with the BITCOIN blockchain 122. In particular, the Blockchain Writer 159 may utilize suitable software/hardware components, e.g., packages for btcsuite, to write the Birth Certificate 154 and the Closing Seal 156 to the BITCOIN blockchain 122, as described in greater detail below in discussion of FIG. 4 and FIG. 8, respectively.

The various components of the server computer system 102 may all be connected by a data/control bus 130. The processor 124 of the server computer system 102 is in communication with an associated Database 144 via a link 138. A suitable communications link 138 may include, for example, the public switched telephone network, a proprietary communications network, infrared, optical, or other suitable wired or wireless data communications. The Database 144 is capable of implementation on components of the server computer system 102, e.g., stored in local memory 126, i.e., on hard drives, virtual drives, or the like, or on remote memory accessible to the server computer system 102.

The associated Database 144 corresponds to any organized collections of data (e.g., account information, images, videos, item information, user information, user device information, transaction information, etc.) used for one or more purposes. Implementation of the associated Database 144 is capable of occurring on any mass storage device(s), for example, magnetic storage drives, a hard disk drive, optical storage devices, flash memory devices, or a suitable combination thereof. The associated Database 144 may be implemented as a component of the server computer system 102, e.g., resident in memory 126, or the like.

In one embodiment, the associated Database 144 may include data corresponding to user information 160, order information 162, Item History 168, TxID 164, Status 166 and other corresponding data, e.g., website data hosted by the server computer system 102, URLs of item manufacturers, item listings, price information, and the like. The user information 160 may include, for example, Purchaser Identity, billing information, device 104A-104B identification, address (billing, delivery, etc.), Origination Secrets, and the like. Such user information 160 may be collected by the server computer system 102 during user registration of a user device 104A, 104B, etc., during registration of the associated user, during item purchase, etc., as will be appreciated by those skilled in the art. The Database 144 may include data relating to order information, for example, instructions on the payment method, amount paid/to be paid, delivery information, billing information, authorization information, quantity, or any myriad additional information relating to the ordering and purchasing of a scarce item/170.

The server computer system 102 may include one or more input/output (I/O) interface devices 132 and 134 for communicating with external devices. The I/O interface 134 may communicate, via communications link 136, with one or more of a display device 140, for displaying information, such estimated destinations, and a user input device 142, such as a keyboard or touch or writable screen, for inputting text, and/or a cursor control device, such as mouse, trackball, or the like, for communicating user input information and command selections to the processor 104. The I/O interface 132 may communicate, via communications link 118, with external devices 104A, 104B, BITCOIN blockchain 122, item manufacturer/warehouse system 110 via a computer network 101, e.g., the Internet.

It will be appreciated that the system and method for marking, validating ownership, proving authenticity, tracking provenance, and verifying scarcity of items utilizing cryptology 100 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 1 as a networked set of components, the system and method are capable of implementation on a stand-alone device adapted to perform the methods described herein.

The server computer system 102 may include one or more of a computer server, workstation, personal computer, cellular telephone, tablet computer, pager, combination thereof, or other computing device capable of executing instructions for performing the exemplary method.

According to one example embodiment, the server computer system 102 includes hardware, software, and/or any suitable combination thereof, configured to interact with an associated user, a networked device, networked storage, remote devices, or the like.

The memory 126 may represent any type of non-transitory computer readable medium such as random access memory (RAM), read only memory (ROM), magnetic disk or tape, optical disk, flash memory, or holographic memory. In one embodiment, the memory 126 comprises a combination of random access memory and read only memory. In some embodiments, the processor 104 and memory 126 may be combined in a single chip. The network interface(s) 132, 134 allow the computer to communicate with other devices via a computer network, and may comprise a modulator/demodulator (MODEM). Memory 126 may store data processed in the method as well as the instructions for performing the exemplary method.

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the server computer system 102, executes instructions 128 stored in memory 126 for performing the method set forth hereinafter.

As shown in FIG. 1, one or more user devices 104A and 104B may be in communication with the server computer system 102 via respective communication links 112 and 114, utilizing the computer network 101, e.g., the Internet. In one embodiment, each user device 104A and 104B may be implemented as a smartphone employing an operating system such as iOS, ANDROID, BLACKBERRY, WINDOWS, APPLE, CHROME, or the like. However, it is to be appreciated that the user devices 104A-104B are representative of any personal computing devices, such as personal computers, netbook computers, laptop computers, workstation computers, personal data assistants, web-enabled cellular telephones, tablet computers, proprietary network devices, or other web-enabled electronic devices. The data communications links 112-114 between the server computer system 102 and the user devices 104A-104B may be accomplished via any suitable channel of data communications such as wireless communications, for example Bluetooth, WiMax, 802.11a, 802.11b, 802.11g, 802.11(x), a proprietary communications network, infrared, optical, the public switched telephone network, or any suitable wireless data transmission system, or wired communications. In one embodiment, the user devices 104A-104B may communicate with the server computer system 102 via a cellular data network.

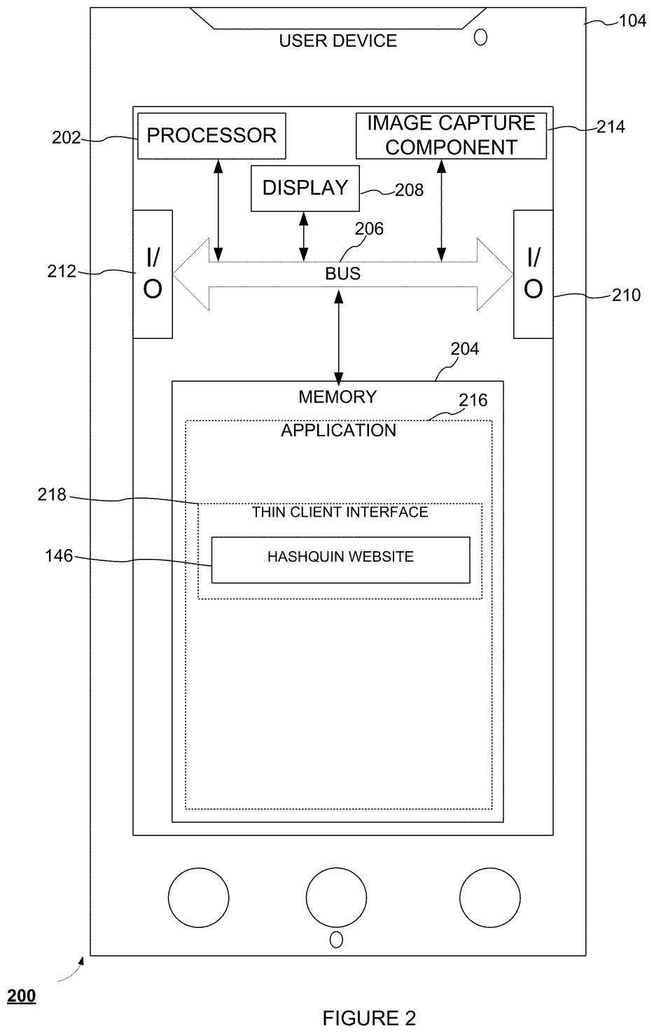

FIG. 2 provides an example illustration of a user device 104 representative of the user devices 104A-104B depicted in FIG. 1. It will be appreciated that the image presented in FIG. 2 is representative of any suitable personal computing device known in the art capable of providing a user with access to the Internet and/or the ability to interact with other electronic devices. Accordingly, while depicted in FIG. 2 as a representative mobile device, any personal computing device may be utilized in accordance with the systems and methods set forth herein. The user device 104 may include a processor 202, which executes one or more instructions or applications 216 in the performance of an exemplary method discussed below. In accordance with one embodiment, the application 216 includes a thin client interface 218 capable of accessing and displaying websites, such as the HashQuin website 146 of the subject embodiments. Suitable non-limiting examples of a thin client interface 218 include, Safari, FireFox, Edge, Dolphin, Chrome, and other such “Internet Browsers” enabling accessing, displaying, and interacting with remote server hosted pages. The skilled artisan will appreciate that such a thin client interface 218 may be adaptable to myriad communication protocols, for both the secure and public transmission and display of information.

It will further be appreciated that the application 216 may be a dedicated “App” installed on the user device 104. In such embodiments, the application 216 is suitably platform independent, e.g., adapted for use across different platforms/operating systems, as will be understood by those skilled in the art. The user device 104 may further include a memory 204 storing the application 216 in data communication with the processor 202 via a system bus 206. The processor 202 of the user device 200 may be in data communication with the server computer system 102 via an I/O interface 212 or I/O interface 210. The user device 104 may further include a display 208 suitably configured to display data to an associated user, receive input from the associated user, and the like. In some embodiments, for example, when part of a mobile device or tablet, the display 208 of the user device 104 may be configured as a touch-screen display capable of receiving user instructions via user contact on the display, e.g., LCD, AMOLED, LED, RETINA, etc., types of touch-screen displays. Alternatively, when the user device 104A-104B is implemented as a desktop or laptop computer or smart TV, the I/O interface 212 or 210 may be coupled to an input device (keyboard/mouse/touchpad/remote), as well as an output device, e.g. a display (monitor), speakers, and the like.

The memory 204 may represent any type of non-transitory computer readable medium such as random access memory (RAM), read only memory (ROM), magnetic disk or tape, optical disk, flash memory, or holographic memory. In one embodiment, the memory 204 comprises a combination of random access memory and read only memory. In some embodiments, the processor 202 and memory 204 may be combined in a single chip. The input/output interface(s) 210, 212 allow the user device 104 to communicate with other devices via a communications network, via Universal Serial Bus or Lightning® ports, via wired or wireless connections, and may comprise a modulator/demodulator (MODEM). Memory 204 may store data processed in the method as well as the instructions for performing the exemplary method. The digital processor 202 can be variously embodied, such as by a single core processor, a dual core processor (or more generally by a multiple core processor), a digital processor and cooperating math coprocessor, a digital controller, or the like.

As shown in FIG. 2, the user devices 104A-104B are capable of intermittent (opportunistic) or continuous bi-directional communication with the central computer system 102 utilizing the I/O interface 212. In one embodiment, for example when the user device 200 is implemented as a mobile device, the bi-directional communication is data communication utilizing a cellular data network, e.g., 3^{rd} generation mobile phone standards (3G), 4^{th} generation standards (4G, 4G LTE, WiMax), EV-DO, standalone data protocols, and the like. The user device 104A-104B may provide user information 160 to the server computer system 102 during registration therewith, e.g. during registration via the website 146. The server computer system 102 may then register the user associated with the user device 104A-104B. The user device 104 depicted in FIG. 2 further includes an image capture component 214, e.g., camera, lens, etc., in communication with the processor 202 and memory 204 via the bus 206. In varying embodiments, the image capture component 214 is configured to capture an image of the physical representation of an Origination Hash/QR Code 172 (e.g., QR code, Origination Hash 152) physically affixed or embedded on the item 170. According to such an embodiment, the image captured by the component 214 may be processed via the user device 104A-104B to retrieve the corresponding alphanumeric symbols of the Origination Hash 152, is sent to the server computer system 102 via the website 146 for processing thereon, or some combination there between.

As shown in FIG. 1, the system 100 further includes an item manufacturer/warehouse 110 in communication with the server computer system 102 via the computer network 101. The item manufacturer/warehouse 110 (hereinafter “item manufacturer 110), as will be appreciated by the skilled artisan, is representative of a storage facility storing scarce items 170, a manufacturer of scarce items 170, or a combination thereof. For example, the item manufacturer 110 may function as a single entity, producing both the finished item 170 and the Origination Hash/QR Code 172, storing previously produced items 170 and manufacturing the Origination Hash/QR Code 172 to be adhered thereto, storing the items 170 and receiving a Origination Hash/QR Code 172 from the system 102 for attachment thereto, a distribution venue, or any suitable combination thereof. According to one embodiment, the item manufacturer 110 is communicatively coupled to the computer network 101 via a suitable communications link 116. As will be appreciated by those skilled in the art, the communications link 116 may include, for example, the public switched telephone network, a proprietary communications network, infrared, optical, or other suitable wired or wireless data communications.

In accordance with one embodiment, the item manufacturer 110 is configured to receive order information 162 from the server computer system 102 regarding a particular purchase of an item 170. The item manufacturer 110 then processes the order information 162 and identifies the item 170 to be manufactured or retrieved. The item manufacturer 110 then produces an Origination Hash/QR Code 172 corresponding to the Origination Hash 152 associated with the order information 162. Preferably, the Origination Hash 152 is received securely from the server computer system 102 in association with the corresponding order information 162. The item manufacturer 110 then attaches the Origination Hash/QR Code 172 to the item 170, and dispatches the item 170 to the purchaser or server computer system 102 location for subsequent delivery to the purchaser. It will be understood that the location of the Origination Hash/QR Code 172 on the item 170 depends upon the type of item 170, such that the Origination Hash/QR Code 172 may be located inside a shoe, under a cuff (article of clothing), inside a seam (article of clothing), on a clasp (jewelry/watch), and the like. In varying embodiments, the Origination Hash/QR Code 172 is located in a discrete position on the item 170, known to the owner and whomever the owner wishes to share. Alternatively, the Origination Hash/QR Code 172 may be positioned/affixed on the item 170 in a conspicuous place, providing an indication to any viewer as to the authenticity of the item 170.

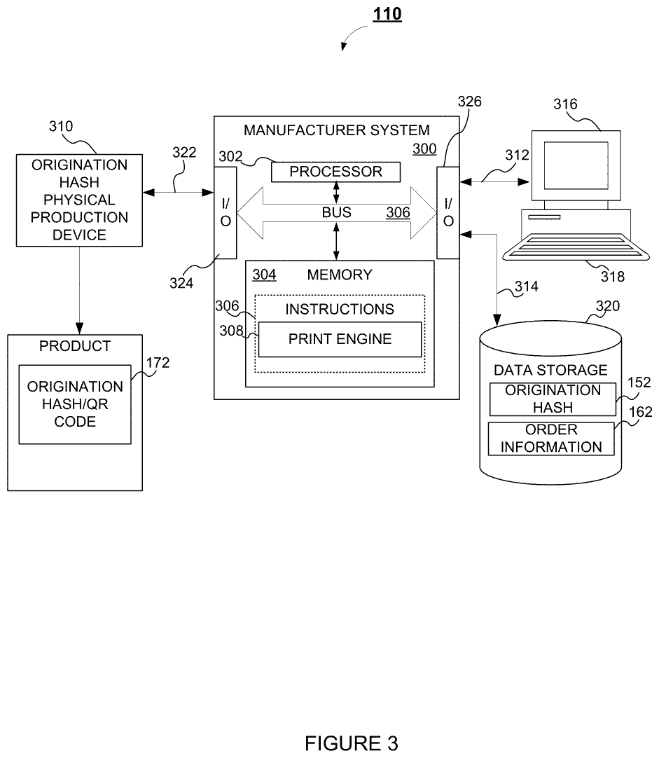

Turning now to FIG. 3, there is shown an illustrative block diagram of a suitable manufacturer computer system 300 of the item manufacturer 110 in accordance with one embodiment of the subject application. The various components of the manufacturer computer system 300 may be connected by a data/control bus 306. The processor 302 of the manufacturer computer system 300 is in communication with an associated Database 320 via a link 314. A suitable communications link 314 may include, for example, the public switched telephone network, a proprietary communications network, infrared, optical, or other suitable wired or wireless data communications. The Database 320 is capable of implementation on components of the manufacturer computer system 300, e.g., stored in local memory 304, i.e., on hard drives, virtual drives, or the like, or on remote memory accessible to the manufacturer computer system 300.

The associated Database 320 is representative of any organized collections of data (e.g., account information, images, videos, item information, user information, item information, transaction information, etc.) used for one or more purposes. Implementation of the associated Database 320 is capable of occurring on any mass storage device(s), for example, magnetic storage drives, a hard disk drive, optical storage devices, flash memory devices, or a suitable combination thereof. The associated Database 320 may be implemented as a component of the manufacturer computer system 300, e.g., resident in memory 304, or the like. In one embodiment, the associated Database 320 may include data corresponding to an Origination Hash 152, order information 162, item catalog, manufacturing instructions, inventory information (e.g., quantity, location, etc.), shipping information, device control information, price information, and the like.

The manufacturer computer system 300 may include one or more input/output (I/O) interface devices 324 and 326 for communicating with external devices. The I/O interface 326 may communicate, via communications link 312, with one or more of a display device 316, for displaying information, such estimated destinations, and a user input device 142, such as a keyboard or touch or writable screen, for inputting text, and/or a cursor control device, such as mouse, trackball, or the like, for communicating user input information and command selections to the processor 104. The I/O interface 132 may communicate, via communications link 322, with external devices such as the server computer system 102, the Origination Hash physical production device 310, via a computer network 101, e.g., the Internet.

It will be appreciated that the item manufacturer 110 illustrated in FIG. 3 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 3 as a networked set of components, the item manufacturer 110 and is capable of implementation on a stand-alone device adapted to interact with the system 100 described herein.

The manufacturer computer system 300 may include one or more of a computer server, workstation, personal computer, cellular telephone, tablet computer, pager, combination thereof, or other computing device capable of executing instructions for performing the exemplary method.

According to one example embodiment, the server computer system 102 includes hardware, software, and/or any suitable combination thereof, configured to interact with an associated user, a networked device, networked storage, remote devices, or the like.

The memory 304 may represent any type of non-transitory computer readable medium such as random access memory (RAM), read only memory (ROM), magnetic disk or tape, optical disk, flash memory, or holographic memory. In one embodiment, the memory 304 comprises a combination of random access memory and read only memory. In some embodiments, the processor 302 and memory 304 may be combined in a single chip. The network interface(s) 324, 326 allow the computer to communicate with other devices via a computer network, and may comprise a modulator/demodulator (MODEM). Memory 304 may store data processed in the method as well as the instructions for performing the exemplary method.

The digital processor 302 can be variously embodied, such as by a single core processor, a dual core processor (or more generally by a multiple core processor), a digital processor and cooperating math coprocessor, a digital controller, or the like. The digital processor 302, in addition to controlling the operation of the manufacturer computer system 300, executes instructions 306 stored in memory 304 for performing the method set forth hereinafter. In accordance with one embodiment contemplated herein, the instructions 306 include a print engine 308 configured to receive the Origination Hash 152 and operate the Origination Hash physical production device 310 to produce (e.g., print, form, mold, or otherwise manufacture) the Origination Hash/QR Code 172 to be affixed to the item 170. The skilled artisan will appreciate that the print engine 308 comprises hardware, software and/or a combination thereof configured to control a printing device i.e., the physical production device 310 (e.g., inkjet, fabric, loom, injection molding, 3D printer, etc.) to generate a physical representation 172 of the Origination Hash 152. Suitable examples may include, without limitation, a plastic/rubber tag, fabric tag, metal tag, or the like, depicting either the alphanumeric characters of the Origination Hash 152 or a QR code of the Origination Hash 152.

The Origination Hash/QR Code 172 is thereafter affixed to the item 170 via any suitable means, e.g., sewn, stamped, formed directly on, glued, or otherwise attached to the item 170. The location of the Origination Hash/QR Code 172 is dependent upon the material of the Origination Hash/QR Code 172 as well as the type of item 170 being so authenticated. In some embodiments, the Origination Hash/QR Code 172 is readily located on the item 170 and visible to even the casual observer. In other embodiments, the Origination Hash/QR Code 172 is discretely located, wherein only the owner the item 170 (interested buyer, authentication experts, etc.) is capable of locating such hash 172.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

In accordance with another aspect of the present disclosure and with reference to FIG. 4, a flowchart of an exemplary method 400 for marking and authenticating scarce items is provided. In particular, FIG. 4 illustrates the initial purchase and creation of an item 170 in accordance with the system and method set forth herein. In some embodiments, the method 400 is implemented as a software program on a computing device. In other embodiments, the method 400 is implemented as a plug-in platform for use with other applications (third party web-based applications or mobile applications).

The exemplary method 400 of FIG. 4 begins at 402 with the server system 102 receiving user information 160 from a user of an associated user device 104A via the computer network 101. In some implementations, the user information 160 includes a name, address, payment information, Purchaser Identity, Origination Secret or other identifying information associated with the user and/or user device 104A. Preferably, this information 160 is received via interactions of the user and the website 146 accessed via the thin client interface 218 on the corresponding user device 104A.

At 404, the server computer system 102 receives, via the website 146, item selection from the associated user of a particular item 170 available for authentication and purchase. Payment is received from the user device 104A at 406 via the computer network 101 by the Payment Monitor 158 of the server computer system 102. It will be understood that the payment received by the Payment Monitor 158 may be in the form of credit card payment (utilizing a third-party payment processor or suitable plugin component, e.g., the Stripe plugin for WooCommerce), BITCOIN payment, gift card payment, or the like. In some embodiments, when BITCOIN is tendered as the payment method, the Payment Monitor 158 may access a self-hosted (i.e. on the server computer system 102) instance of a BTCPay Server (an open-source project). The user is then prompted, at 408, to input the Purchaser Identity and an Origination Secret, as illustrated in the screenshot 900 of FIG. 9, depicting a displayed image from the website 146.

The Hash Generator 150 then generates an Origination Hash 152 to uniquely identify the item 170 at 410. According to one embodiment, to generate the Origination Hash 152 for unique identification of the item 170, the Hash Generator 150 takes the Origination Hash Item Details entered by the user during purchase to generate an SHA-256 hash in accordance with the FIPS 180-4 algorithm. Concurrently at 410 with the generation of the Origination Hash 152 is the generation of a QR code, which allows users to more easily enter/lookup the OH 152 associated with a particular item 170. At 412, the Hash Generator 150 generates a Hash Print 155. The Hash Print 155 is an SHA-256 hash of the Origination Hash 152.

The Birth Certificate 154 is then written to the BITCOIN blockchain 122 at 414 by the Blockchain Writer 159 of the server computer system 102. The skilled artisan will appreciate that the methods described hereinafter regarding writing to the blockchain 122 utilize specific programs for purposes of illustrating an example methodology to perform the writing. Accordingly, other programs and procedures may be used in addition to or in place of these example implementations. Thus, one of ordinary skill in the art will appreciate that the following description is non-limiting and intended to illustrate one possible method, and that other methods, not described, are included in the subject application. The Blockchain Writer 159 utilizes “Script”, a scripting language used within the Bitcoin protocol. In particular, it utilizes “OP_RETURN”, a script opcode that allows a transaction to contain 80 bytes of arbitrary data in a BITCOIN transaction. The Blockchain Writer 159 may also include a copy of “bitcoind”, a program utilized to allow Remote Procedure Calls (RPC) to be made. The Blockchain Writer 159 monitors the databases 144 for items 170 that have been identified as paid by the Payment Monitor 158. The Blockchain Writer 159 checks to ensure that the Birth Certificate 154 has been generated for the item 170, and then the item enters a FIFO queue.

An RPC connection to bitcoind is established by the Blockchain Writer 159, which then performs a “listunspent” call to retrieve a list of Unspent Transactions (UTXOs). A UTXO is selected, and then the number of confirmations for the selected UTXO is checked. If the number of confirmations is less than 3, it moves onto the next UTXO in the list and checks the number of confirmations. If the entire list of UTXOs is exhausted without finding a UTXO with 3 or more confirmations, the item 170 remains in the queue, and the Blockchain Writer 159 continues to check the list of UTXOs until it finds a UTXO with sufficient confirmations. Once a suitable UTXO is selected, the Blockchain Writer 159 performs an “estimatesmartfee” RPC call to determine what fee must be paid for a 1 KB transaction to ensure it is confirmed within a timely fashion. The skilled artisan will appreciate that the fee referenced herein is payable to the BITCOIN blockchain 122. The Blockchain Writer 159 then multiplies this fee by the size (bytes) of a HashQuin transaction to determine the proper fee amount.

The Blockchain Writer 159 then performs a “getrawchangeaddress” call to retrieve a change address for the transaction. In order to ensure the system 100 does not lose excess funds, the Blockchain Writer 159 subtracts the previously determined fee from the amount of BITCOIN associated with the selected UTXO. The difference is then stored as the “change” amount for this transaction in the associated Database 144.

A safety check is then performed by the Blockchain Writer 159 to ensure that the Birth Certificate 154 is under the 80 byte maximum for OP_RETURN data. If it exceeds this amount, an error is raised and the process is aborted. The chance of this is unlikely due to other checks commonly occurring during the movement of data, (e.g., checksums, etc.) performed by the Hash Generator 150, as will be appreciated by those skilled in the art. The Blockchain Writer 159 then begins the process of creating a raw transaction. To do so, the Blockchain Writer 159 generates an Input from the transaction ID 164 (TxID) and Vout of the stored UTXO.

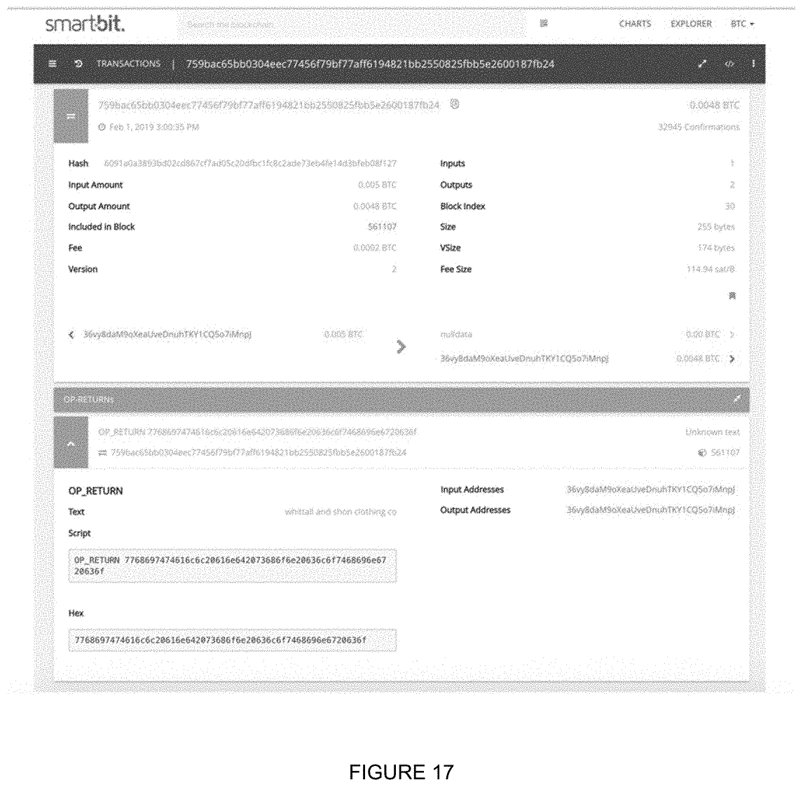

Next, the Blockchain Writer 159 determines an Output from the change address, the change amount, and data associated with the Birth Certificate 154. The Input and Output are then combined by the Blockchain Writer 159 to generate a JavaScript Object Notation (JSON) representation of the transaction. The Blockchain Writer 159 then performs a “createrawtransaction” RPC call using the JSON. Thereafter, the blockchain writer 159 performs a “signrawtransactionfromwallet” RPC call, which returns a hexadecimal representation of the signed transaction. This hexadecimal representation is then marshaled into JSON, and a “sendrawtransaction” RPC call is performed by the Blockchain Writer 159 using this JSON representation of the signed raw transaction. The result of this call is that the TxID 164 of the transaction has been written to the BITCOIN blockchain 122. At this point, the item 170 is updated in the Database 144 with the TxID 164, so that users can easily find the Birth Certificate 154 associated with their item 170 on the BITCOIN blockchain 122. An example illustration of the BITCOIN blockchain 122 is shown in FIG. 17, wherein the Birth Certificate 154 and TxID are depicted and stored thereon.

Returning to FIG. 4, after the transaction via the Birth Certificate 154 has been written to the BITCOIN blockchain 122, operations proceed to 416, whereupon the item manufacturer 110 produces a physical representation 172 of the Origination Hash 152 (e.g., the QR code 156) and affixes the Origination Hash/QR Code 172 to the item 170. The authentic item 170 with the Origination Hash/QR Code 172 affixed thereto is then delivered to the user at 418 in accordance with the user information 160 and order information 162 associated with the item 170.

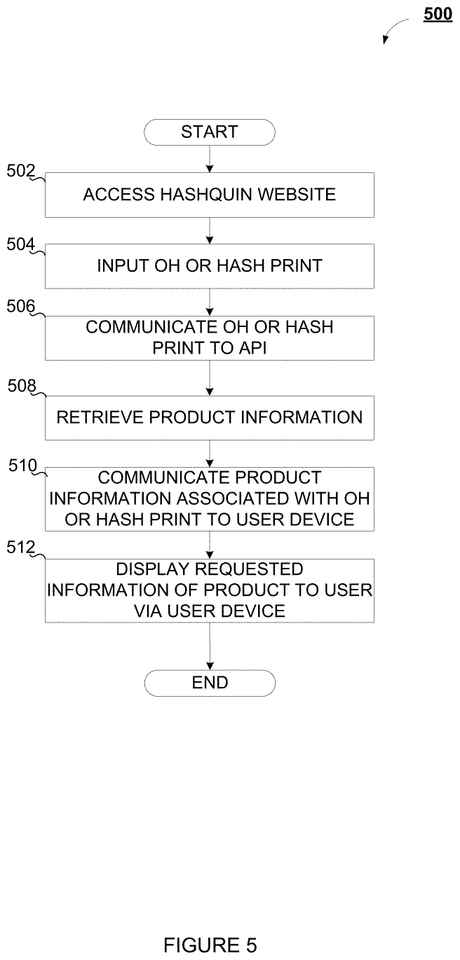

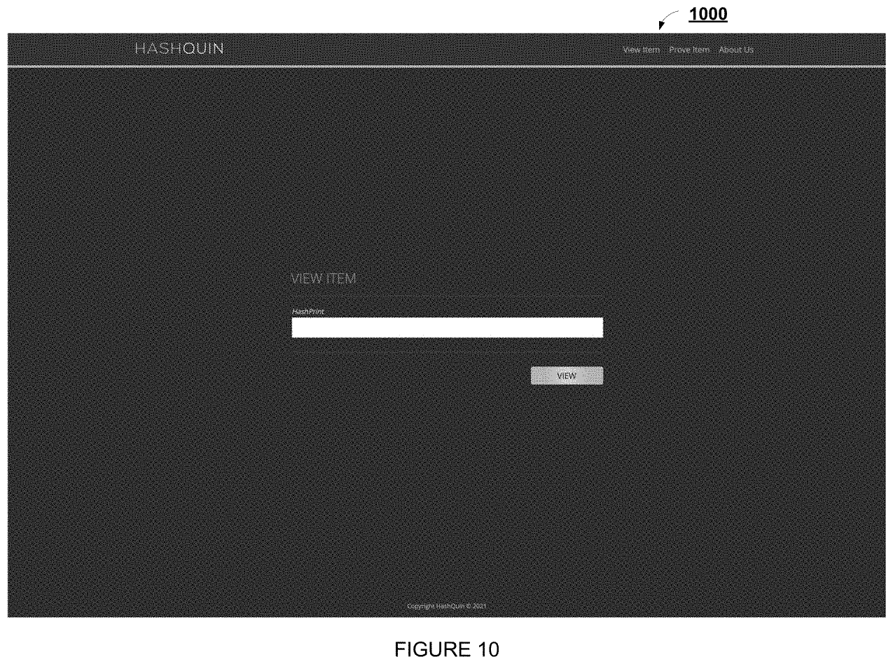

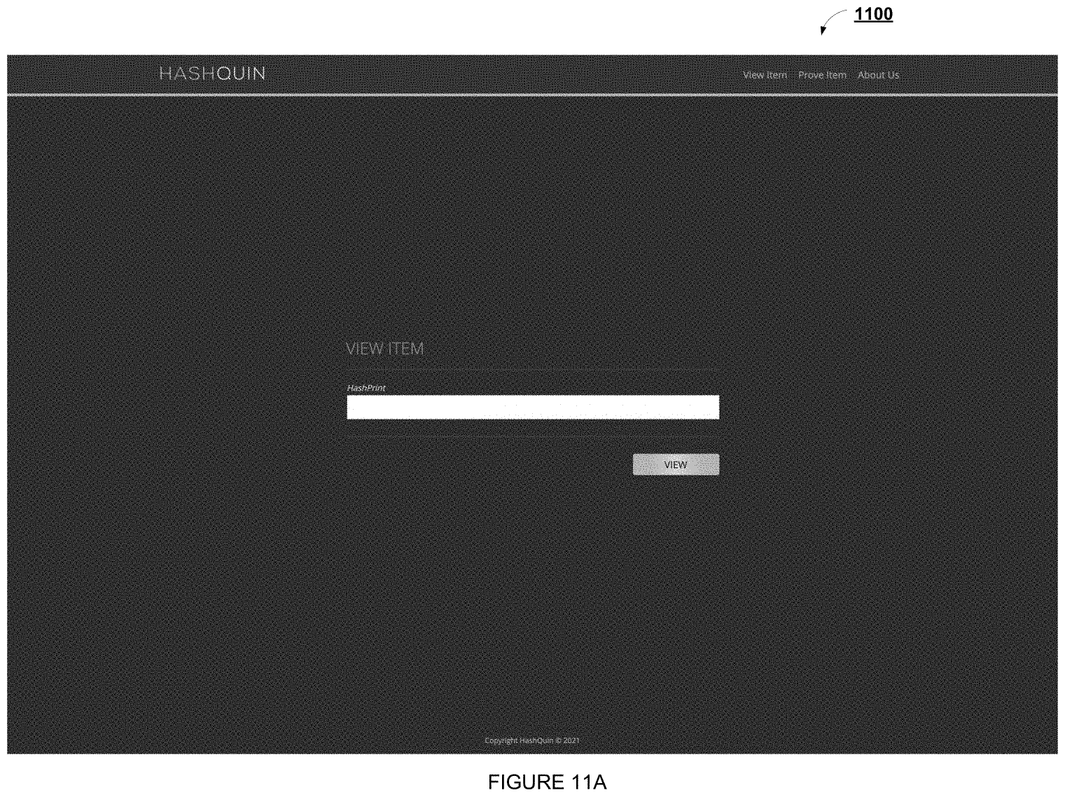

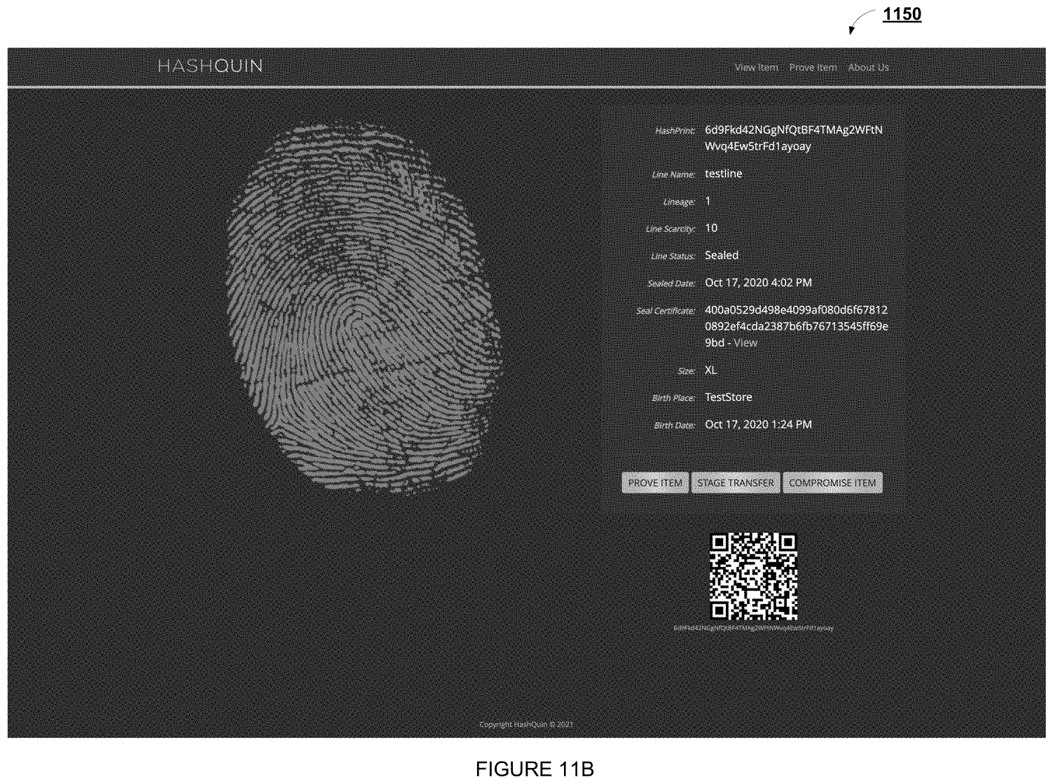

Referring now to FIG. 5, there is shown a flowchart 500 of an exemplary method for verifying authenticity/provenance of scarce items 170 in accordance with one aspect of the exemplary embodiment. As shown in FIG. 5, a user via a user device 104A accesses the HashQuin website 146 hosted by the server computer system 102 (or third-party service) via the computer network 101 at 502. FIG. 10 illustrates a screenshot 1000 of the website 146 for public authentication of an item 170 in accordance with the methodology of FIG. 5. FIG. 11A illustrates a screenshot 1100 of the website 146 for private authentication of an item 170 in accordance with the methodology of FIG. 5, i.e., for the owner of the item 170. At 504, the QR code is scanned by the image capture component 214 of the user device 104 to input the Origination Hash 152. The skilled artisan will appreciate that the user may manually input the Origination Hash 152 or the Origination Hash 155 via suitable input mechanisms of the user device 104 to the website 146, and the use of scanning the QR code 156 is intended to simplify entry thereof.

The Origination Hash 152 or the Hash Print 155 or the Latest Hash Print 157 is then communicated, via the network 101, to the HashQuin API 148 of the server computer system 102 at 506. The HashQuin API 148 then retrieves item information at 508. It will be understood that when publicly accessing the item information with the Origination Hash or the Latest Origination Hash via the website 146, only the Retrieval Details will be provided. Thus, upon input of a valid Hash Print 155 or Latest Hash Print 157 an API call is performed by the HashQuin API 148 to look up the Origination Hash 152 in the Database 144, and retrieves limited information, the Retrieval Details, about the item 170. When privately accessing the website 146, the user is prompted to enter the Origination Hash 152. This information is communicated via the website 146 to the HashQuin API 148, wherein an API call is performed to the Database 144 and a complete set of details, the Full Item Details of the item 170 is retrieved from the Database 144, as illustrated in the screenshot 1150 of FIG. 11B.

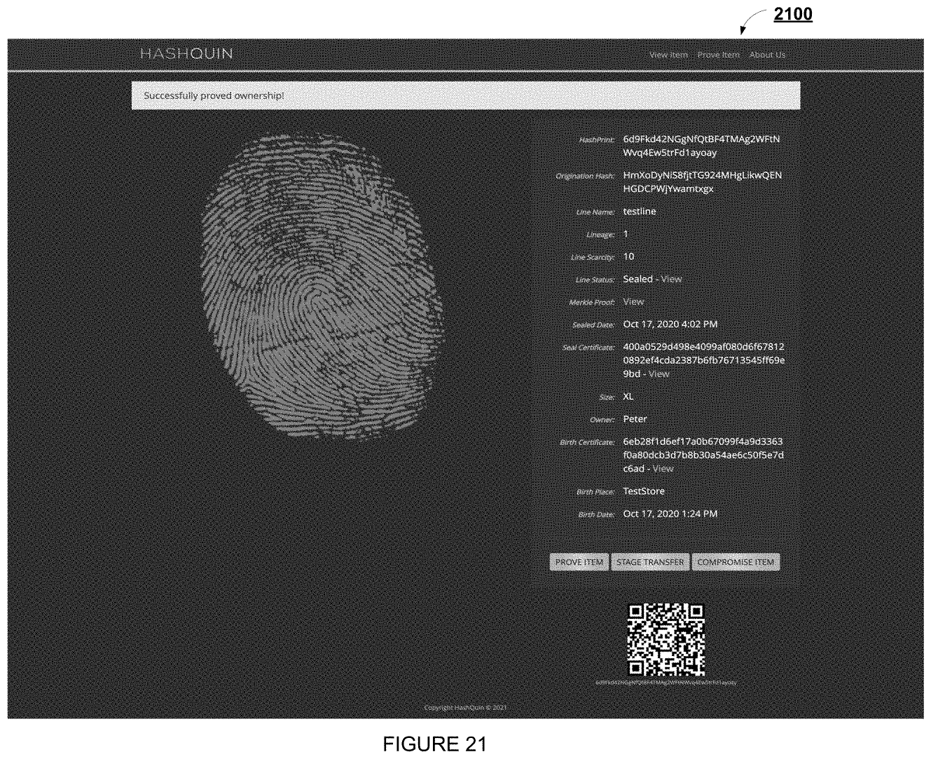

The retrieved item information associated with the Origination Hash 152 is then returned to the requesting user device 104 at 510. Accordingly, this information may be limited or contain the full details about the item 170, depending upon whether public or private access was determined. Thereafter, at 512, the Retrieval Details or the Full Item Details of the item 170 associated with the Origination Hash 152 is displayed via the website 146 operable on the thin client interface 218 of the user device 104. FIG. 21 illustrates a detail screen 2100 after proving ownership in accordance with one embodiment of the subject application.

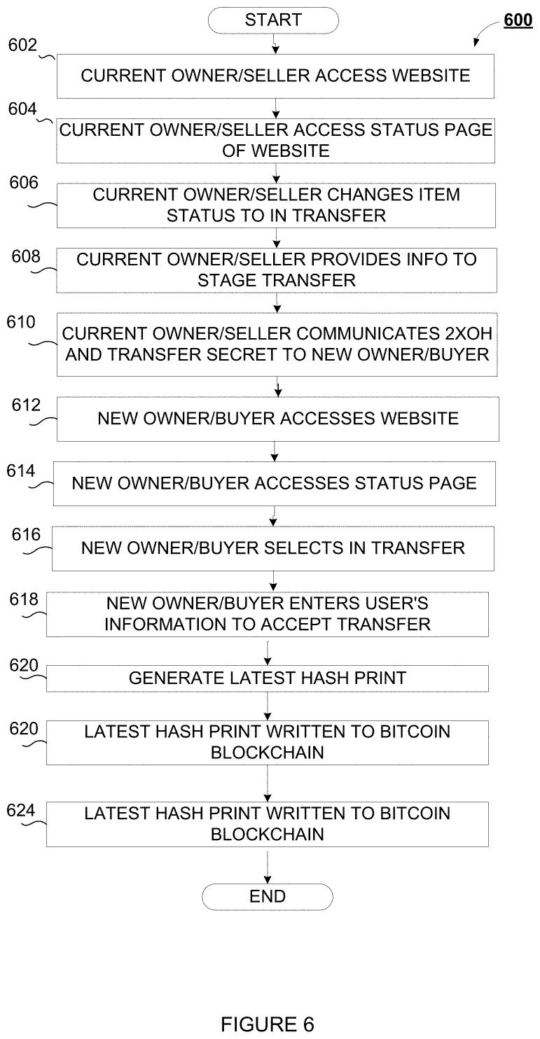

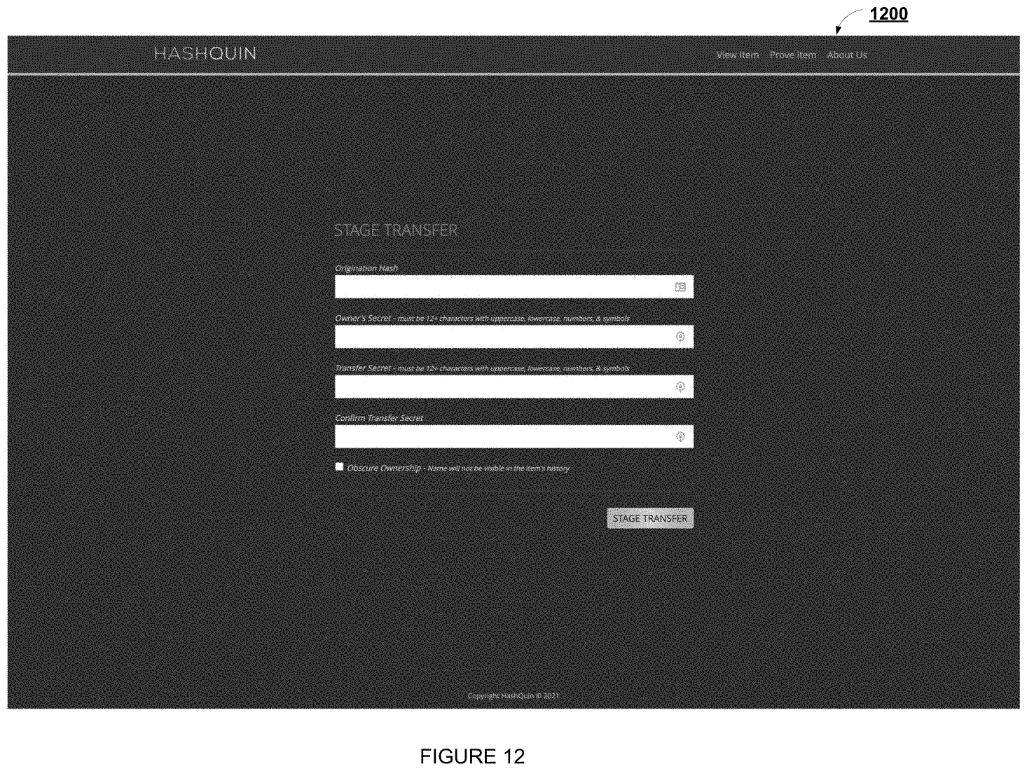

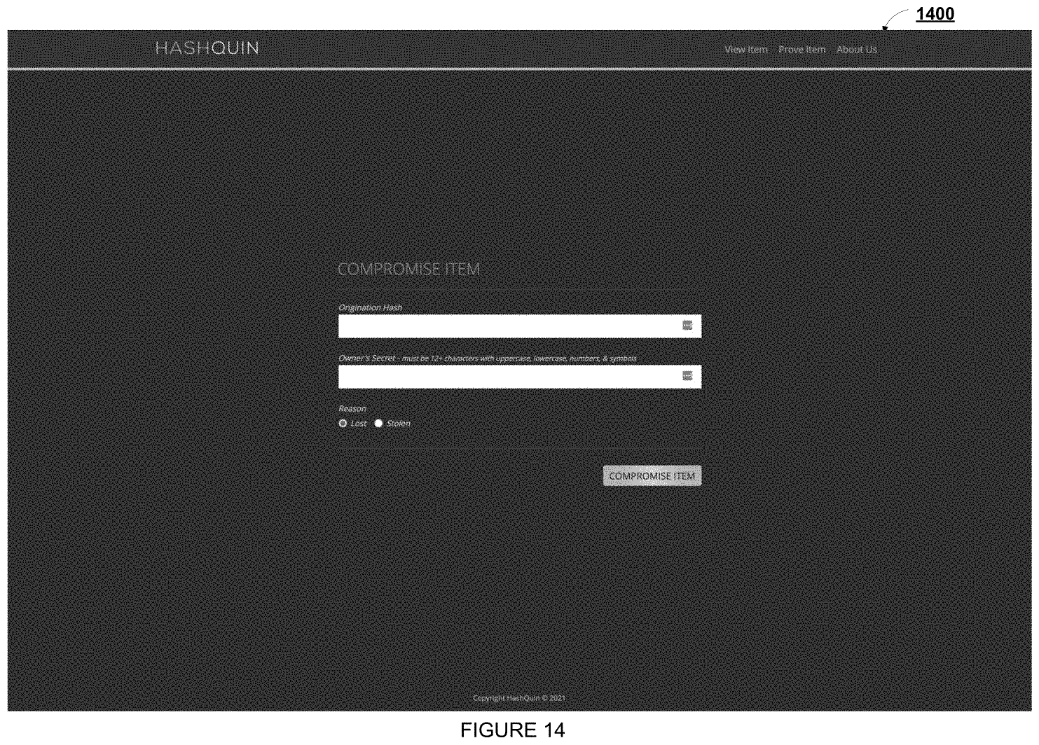

Turning now to FIG. 6, there is shown a flowchart 600 illustrating an exemplary method for Transferring Ownership of scarce items in accordance with one aspect of the exemplary embodiment. To exemplify this transfer, the current owner/Seller is described as associated with the user device 104A and the new owner/Buyer is described subsequently as associated with the user device 104B. The Transfer of an item 170 verified in accordance with the methodology set forth above in FIG. 5 begins at 602, with the current owner/Seller of the item 170 accessing the website. The current owner/Seller accesses the Status page of the website at 604. At 606, the current owner/Seller changes the item Status 166 to In Transfer as illustrated in FIG. 14 as the exemplary screenshot 1400. When the item's Status 166 is changed to In Transfer, the current owner/Seller will be prompted to provide the Hash Print 155, the Transfer Secret and the Origination Secret at 608, as illustrated in FIG. 12 as the exemplary screenshot 1200. The QR code is scanned by the image capture component 214 of the user device 104A to input the Origination Hash 152, or the user 104A manually inputs the Origination Hash 152 via suitable input mechanisms of the user device 104A to the website 146. The Origination Hash 152 is thereafter then communicated, via the network 101, to the HashQuin API 148 of the server computer system 102.

At 610, the current owner/Seller provides the new owner/Buyer with the Transfer Secret and the current owner/Seller provides the Hash Print 155 of the item to the new owner/Buyer. This is accomplished via a pre-established communications channel outside the HashQuin system 100.

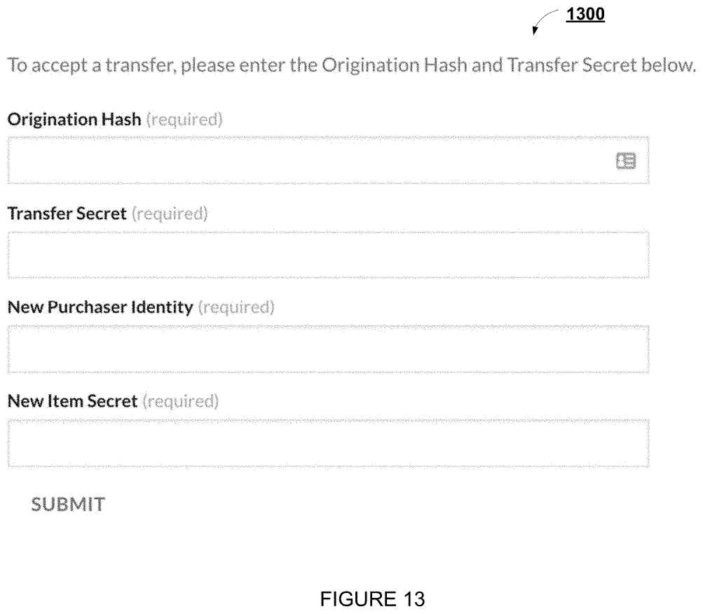

The new owner/Buyer accesses the website at 612. The new owner/Buyer accesses the Status page of the website at 614. The new owner/Buyer selects In Transfer at 616 as illustrated in FIG. 12 as the exemplary screenshot 1200. The new owner/Buyer accepts Transfer by providing the Origination Hash 152, the Transfer Secret, inputting a new Purchaser Identity and a new Origination Secret at 618 as illustrated in FIG. 13 as the exemplary screenshot 1300. The QR code is scanned by the image capture component 214 of the user device 104A to input the Origination Hash 152, or the user 104A manually inputs the Origination Hash 152 via suitable input mechanisms of the user device 104A to the website 146. The Origination Hash 152 is thereafter then communicated, via the network 101, to the HashQuin API 148 of the server computer system

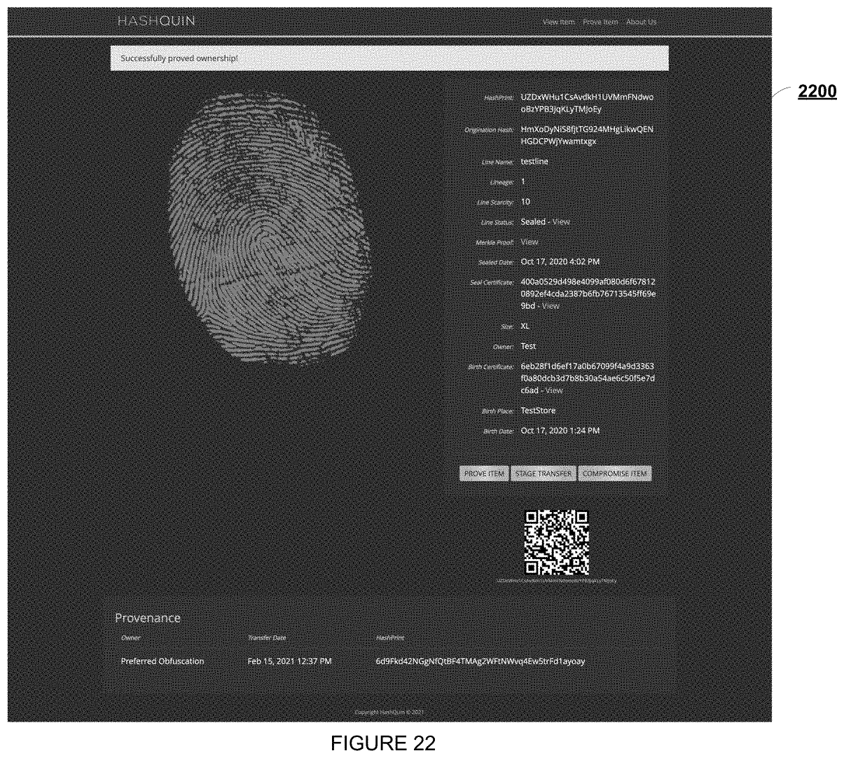

At 620 the Origination Hash 152, the Purchaser Identity of the new owner/Buyer and the Origination Secret of the new owner/Buyer are hashed to generate the Latest Hash Print 157. The Latest Hash Print 157 is then written to the BITCOIN blockchain 122 at 622 by the Blockchain Writer 159 of the server computer system 102. The skilled artisan will appreciate that the methods described hereinafter regarding writing to the blockchain. Finally, at 624, the Latest Hash Print 157 is added to the Database 144. The Latest Hash Print 157 is included in the Retrieval Details and the Full Item Details. FIG. 22 provides an illustration of one possible post-transfer Item details after transfer screen 2200 in accordance with one example embodiment of the subject disclosure.

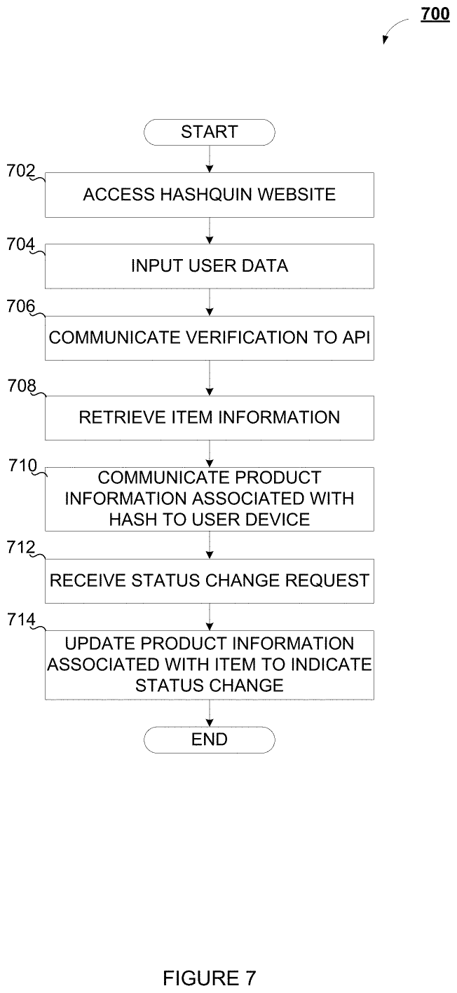

Turning now to FIG. 7, there is shown a flowchart 700 of an exemplary method for reporting a change of Status for items 170 in accordance with one aspect of the exemplary embodiment. The method shown in FIG. 7 begins at 702, whereupon a user via a user device 104 accesses the HashQuin website 146 hosted by the server computer system 102 (or third party service) via the computer network 101. FIG. 14 illustrates a screenshot 1400 of the website 146 to change the Status 166 of an item 170. At 704, the Origination Hash 152, the Original Secret and the Purchaser Identification are input. The QR code is scanned by the image capture component 214 of the user device 104 to input the Origination Hash 152. It will be appreciated to those skilled in the art that that the user may manually input the Origination Hash 152 via suitable input mechanisms of the user device 104 to the website 146, and the use of scanning the QR code is intended to simplify entry thereof.

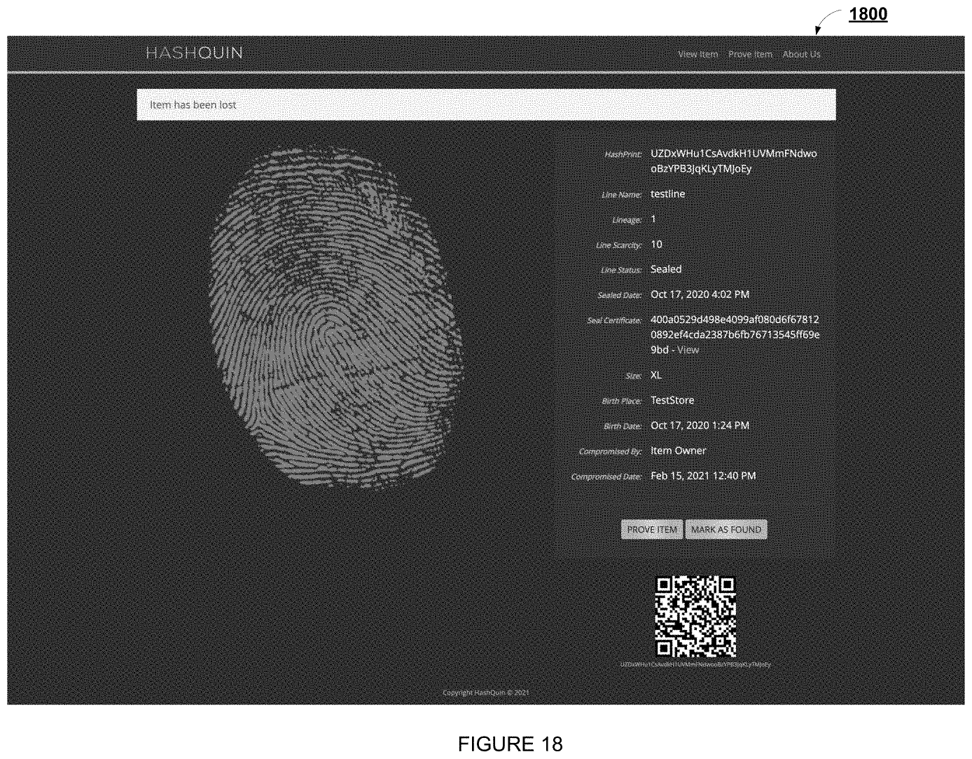

The Origination Hash 152 is then verified and communicated, via the network 101, to the HashQuin API 148 of the server computer system 102 at 706. The HashQuin API 148 then retrieves item information at 708. The retrieved item information associated with the Origination Hash 152 is then returned to the requesting user device 104 at 710. At 712, request to change the Status 166 of an item 170 is then received by the HashQuin API 148 via the website 146 at the server computer system 102. The item information in the Database 144 associated with the server computer system 102 and website 146 is then updated at 714 to indicate that the Status 166 of item 170 associated with the Origination Hash 152 is changed, i.e., Stolen, Lost, Compromised, In Transfer etc. FIG. 18 depicts an exemplary screenshot 1800 illustrating the status of an item designated as compromised, e.g., “Lost”. Thereafter, the skilled artisan will appreciate that any subsequent purchasers of the item 170 utilizing the public access described above with respect to FIG. 5 will be able to readily determine whether an item 170 is counterfeit, stolen, or the like.

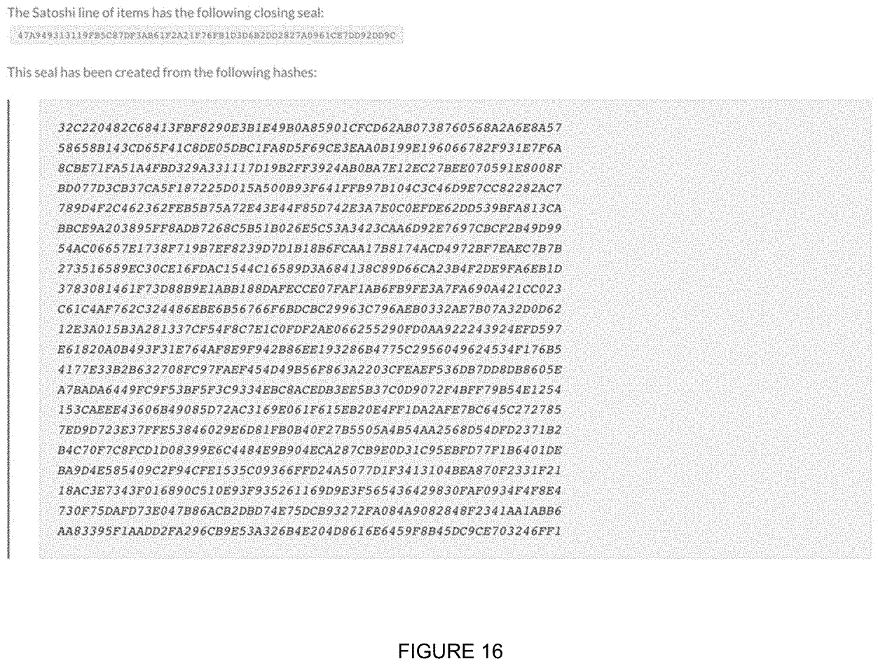

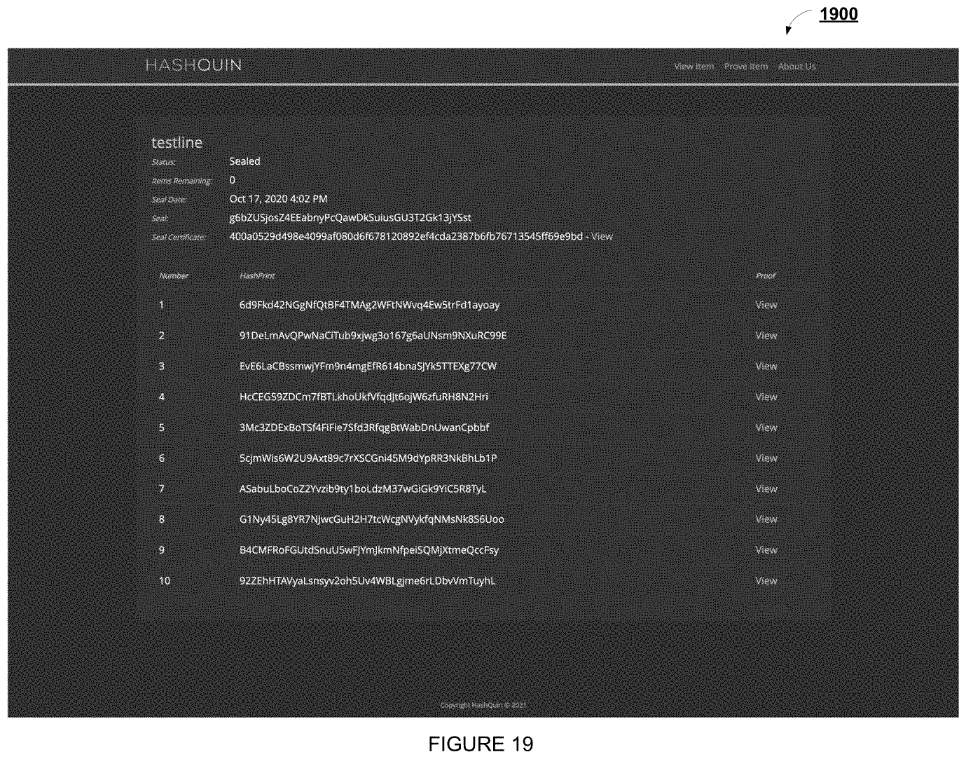

Referring now to FIG. 8, there is shown a flowchart 800 of an exemplary method for Sealing a Line after all items 170 in a Line have been purchased in accordance with one aspect of the exemplary embodiment. The method shown in FIG. 8 begins with the completion of the purchases of all items 170 in a Line at 802. The Line then goes through the Sealing process at 804. Once the Sealing process is completed, at 806 a Closing Seal 156 is generated. The Closing Seal 156 is included with an item's Retrieval Details and Full Item Details in the Database 144 at 808. The Closing Seal 156 and the Sealing Date are written to the BITCOIN Blockchain 122 at 810. Exemplary screens 1600 and 1900 of FIGS. 16 and 19, respectively, illustrate varying examples of Sealed Lines in accordance with one embodiment of the subject disclosure.

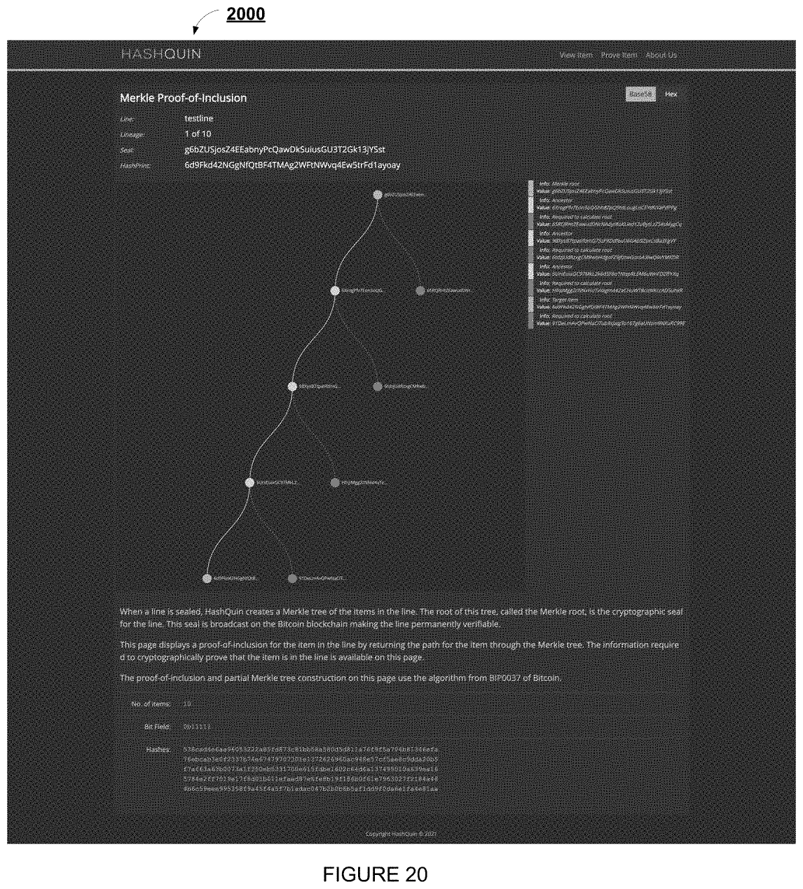

In accordance with one embodiment of the subject disclosure, the Line is sealed when all of the items 170 in the lineage are created, forever tying the items in the Line together and imprinting the aforementioned Closing Seal 156 on the Bitcoin blockchain 122 which includes a time stamp and a Merkle Root (a blockchain proof of inclusion in the line) that enables any item in the line to be validated as a part of a finite set in that sealed line (scarcity). After a line is sealed, the current owner of each item 170 in the line has the ability to validate that the item is indeed part of that line. If the line uses pre-hashed creation, until the item is transferred to the first owner, the Seller may access the Merkle proof to view this validation in two ways from the “Prove Item” menu. Individual item: Click the “view” link next to Merkle Proof. This will send you to the “Merkle Proof-of-Inclusion” screen on the HashQuin website containing the following: Line name; Lineage; Seal (a hashed version of all of the HashPrints of the items in the line); HashPrint of the target item being validated; and a visual representation of the proof including the target item's Hash Print at the bottom of the tree traced back to Merkle Root at the top (the Seal hash). The option to toggle between Hexadecimal and Base 58 representations of the hashes using the buttons on the upper right hand section of the screen. Alternatively, for a Full line view, Click the “view” link next to “Line Status-Sealed”. This will send the user to the Sealed line page on the HashQuin website containing the following: Line name; Items remaining (which will be 0 for sealed lines); Seal date; Seal (a hashed version of all of the HashPrints of the items in the line); Seal certificate link, immortalizing the line on the Bitcoin blockchain; and the HashPrint list of all of the items in the sealed line, each with a link to the Merkle Proof-of-Inclusion screen that proves that the item is indeed a part of the seal. FIG. 20 illustrates an exemplary Merkle Proof-of-Inclusion screen 2000 in accordance with one embodiment of the subject application.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. A method for marking, validating ownership, proving authenticity, tracking provenance, and verifying scarcity of items utilizing cryptology, comprising:
with a Hash Generator, generating an Origination Hash associated with a specific item;
generating a hash from the Origination Hash;
writing, with a Blockchain Writer, a Birth Certificate associated with the hash from the Origination Hash to the BITCOIN blockchain; and
physically marking the specific item with the Origination Hash.

2. The method for marking, validating ownership, proving authenticity, tracking provenance, and verifying scarcity of items utilizing cryptology of claim 1, further comprising:
accessing a website by a first user device via a computer network;
inputting the Origination Hash via the website; and
receiving authentication information Full Item Details regarding the specific item associated with the Origination Hash.

3. The method for marking, validating ownership, proving authenticity, tracking provenance, and verifying scarcity of items utilizing cryptology of claim 1, further comprising:
accessing a website by a first user device via a computer network;
inputting the hash from the Origination Hash via the website; and
receiving authentication information Retrieval Details regarding the specific item associated with the hash from the Origination Hash.

4. The method for marking, validating ownership, proving authenticity, tracking provenance, and verifying scarcity of items utilizing cryptology of claim 1, wherein the Hash Generator and the Blockchain Writer are resident on a server in data communication with an associated computer network.

5. The method for marking, validating ownership, proving authenticity, tracking provenance, and verifying scarcity of items utilizing cryptology of claim 1, wherein physically marking the specific item further comprises affixing a Hard Marker comprising a physical identifier to the item.

6. The method for marking, validating ownership, proving authenticity, tracking provenance, and verifying scarcity of items utilizing cryptology of claim 1, wherein the Origination Hash is implemented on the specific item as at least one of an alphanumeric sequence of numbers or a QR code.

7. The method for method for marking, validating ownership, proving authenticity, tracking provenance, and verifying scarcity of items utilizing cryptology of claim 1, wherein the Hash Generator generates the Origination Hash in accordance with SHA-256.

8. The method for marking, validating ownership, proving authenticity, tracking provenance, and verifying scarcity of items utilizing cryptology of claim 1, wherein the specific item is selected from the group of an article of clothing, a pair of shoes, a collectible, a piece of jewelry, an accessory, a piece of memorabilia, or a luxury good.

9. A system for marking, validating ownership, proving authenticity, tracking provenance, and verifying scarcity of items utilizing cryptology, comprising:
a server computer system comprising:
a processor,
a Hash Generator;
a Blockchain Writer;
a Payment Monitor; and
a memory in communication with the processor, the memory storing instructions which are executed by the processor, causing the processor to:
host a website accessible by a plurality of user devices via an associated computer network;
receive, via the website, user information associated with an item;
generate, in accordance with the received user information, a unique Origination Hash via the Hash Generator;
generate, via the Hash Generator, a hash from the Origination Hash; and
write, via the Blockchain Writer, a Birth Certificate associated with the hash from the Origination Hash to the BITCOIN blockchain.

10. The system according to claim 9, wherein the Origination Hash is communicated to an associated item manufacturer via the associated computer network.

11. The system according to claim 10, wherein the associated item manufacturer is configured to:
imprint at least one of an Origination Hash or QR Code corresponding to the received Origination Hash; and
attach the at least one of the Origination Hash or QR Code to the specific item corresponding thereto.

12. The system according to claim 11, wherein the associated item manufacturer is configured to attach a Hard Marker comprising a physical identifier to the item.

13. The system according to claim 12, wherein the Hard Marker comprises at least one of a painted pattern or beads.

14. The system according to claim 10, wherein the Origination Hash is generated in accordance with SHA 256.

15. The system according to claim 14, wherein the hash of the Origination Hash is generated in accordance with SHA 256.

16. The system according to claim 10, wherein the specific item is selected from the group of an article of clothing, a pair of shoes, a collectible, a piece of jewelry, an accessory, a piece of memorabilia, or a luxury good.

17. An article of manufacture manufactured in accordance with the method of claim 1.

18. An article of manufacture comprising a physical Origination Hash affixed to the article.

19. The article of claim 18, wherein the physical Origination Hash is generated by an associated Hash Generator in accordance with SHA 256.

20. The article of manufacture of claim 19, wherein the article is selected from the group of an article of clothing, a pair of shoes, a collectible, a piece of jewelry, an accessory, a piece of memorabilia, or a luxury good.
